(19) United States
(12) Patent Application Publication
(10) Pub. No.: US 2026/0038400 A1
(43) Pub. Date: Feb. 5, 2026

(54) DISPLAY APPARATUS

(71) Applicant: LG Display Co., Ltd., Seoul (KR)

(72) Inventor: Cheolsu LEE, Paju-si (KR)

(73) Assignee: LG Display Co., Ltd., Seoul (KR)

(21) Appl. No.: 19/093,985

(22) Filed: Mar. 28, 2025

(30) Foreign Application Priority Data
Jul. 31, 2024 (KR) 10-2024-0101737

(51) Int. Cl. G09G 3/00; G09G 3/3275

(52) U.S. Cl. CPC G09G 3/006; G09G 3/3275; G09G 2300/043; G09G 2300/0819; G09G 2310/08; G09G 2330/022; G09G 2330/025; G09G 2330/10

(57) ABSTRACT

The present disclosure relates to a display apparatus, and the display apparatus includes a display panel on which a plurality of sub-pixels are arranged, the plurality of sub-pixels each including an organic light-emitting diode and a driving transistor for driving the organic light-emitting diode, a plurality of sensing lines disposed on the display panel, a sensing circuit configured to sense voltages of the plurality of sensing lines, and a controller configured to determine whether the organic light-emitting diode is defective based on pre-stored reference data, wherein a process for determining whether the organic light-emitting diode is defective is performed before an off-sensing process after a power-off signal is generated.

### CROSS REFERENCE TO RELATED APPLICATION

The present application claims the benefit of and priority to Korean Patent Application No. 10-2024-0101737, filed Jul. 31, 2024, the entire contents of which are incorporated herein by reference for all purposes.

### BACKGROUND

### 1. Technical Field

The present disclosure relates to a display apparatus.

### 2. Description of the Related Art

As the information society develops, various demands for display apparatuses for displaying images are increasing, and various types of display apparatuses such as liquid crystal display (LCD) apparatuses and organic light-emitting diode (OLED) display apparatuses are utilized.

Among these display apparatuses, the OLED display apparatus uses OLEDs that emit light by themselves, and thus has advantages in terms of a fast response speed, a contrast ratio, luminance efficiency, luminance, a viewing angle, etc.

Such an OLED display apparatus may include an OLED disposed in each of a plurality of sub-pixels arranged on a display panel and allow the OLED to emit light through current control flowing in the OLED to control the luminance of each sub-pixel and display an image.

Such a display apparatus includes a driving voltage supply source for supplying various driving voltages required for driving a display panel to a driving circuit and the display panel, and various components for transmitting the driving voltages.

Such a display apparatus includes a display panel in which a plurality of sub-pixels are disposed in a matrix form. The display panel receives scan signals from a gate driving circuit and data voltages from a data driving circuit in order to drive each of the sub-pixels. In addition, the display panel receives a plurality of driving voltages from a power management circuit.

At this time, when a crack occurs in the display panel due to various factors, such as an external impact or overheating, a short circuit may occur in components disposed on driving voltage lines of the display panel. For example, a short circuit may occur in a driving transistor that drives the OLED, or a short circuit may occur in the OLED. When an overcurrent flows in the driving voltage line or the display panel due to such a defect, due to the overcurrent, the voltage line can be short-circuited, or the burnt phenomenon in which the display panel is burnt can occur.

The description of the related art should not be assumed to be prior art merely because it is mentioned in or associated with this section. The description of the related art includes information that describes one or more aspects of the subject technology, and the description in this section does not limit the invention.

### SUMMARY

Embodiments of the present disclosure are directed to providing a display apparatus in which it is possible to omit or simplify a component for detecting a short circuit of a driving transistor and/or an organic light-emitting diode.

Embodiments of the present disclosure are also directed to providing a display apparatus which may separately detect degradation of a characteristic value of a driving transistor and short circuits of the driving transistor and/or an organic light-emitting diode using the result of sensing a characteristic value of a previous driving transistor.

Embodiments of the present disclosure are also directed to providing a display apparatus which may detect both short circuits of a driving transistor and/or an organic light-emitting diode in one process.

Embodiments of the present disclosure are also directed to providing a display apparatus which may separately detect a short circuit of a driving transistor and a short circuit of an organic light-emitting diode in one process.

Aspects of the present disclosure are not limited to the above-described aspect, and other aspects that are not described will be able to be clearly understood by those skilled in the art from the following description.

According to one embodiment, there is provided a display apparatus including a display panel on which a plurality of sub-pixels are arranged, each of the plurality of sub-pixels including an organic light-emitting diode and a driving transistor for driving the organic light-emitting diode, a plurality of sensing lines disposed on the display panel, a sensing circuit configured to sense voltages of the plurality of sensing lines, and a controller configured to determine whether the organic light-emitting diode is defective based on pre-stored reference data, wherein a process for determining whether the organic light-emitting diode is defective is performed before an off-sensing process after a power-off signal is generated.

The reference data may be updated based on data acquired by a mobility sensing process of the driving transistor, which is performed in real time during display driving.

The update of the reference data may be performed before the display apparatus is completely turned off after the power-off signal is generated.

The updated reference data may be stored in a non-volatile memory.

The controller may perform defect detection of the organic light-emitting diode based on the reference data stored before last power-off after a last power-off signal is generated.

The reference data may be a slope of a waveform of a sensing line voltage sensed by mobility sensing of the driving transistor, which is performed in real time during display driving, and the reference range may be calculated by adding or subtracting a preset value to or from the reference data.

Mobility sensing of the driving transistor may be performed before display driving after a power-on signal is generated.

The controller may include a memory configured to store the reference data, and a comparator configured to calculate the reference range based on the reference data, compare a slope of a waveform of the sensed voltage with a reference range, and output a defect detection signal of the organic light-emitting diode.

The controller may output a defect detection signal corresponding to a defect of the driving transistor when a slope of a waveform of the sensed voltage is larger than an upper limit of the reference range.

The controller may output a defect detection signal corresponding to a defect of the organic light-emitting diode when a slope of a waveform of the sensed voltage is less than a lower limit of the reference range.

A plurality of pixels may be arranged on the display panel, the pixel may include at least one sub-pixel, and the controller may detect a pixel as defective when the pixel including a sub-pixel of which an organic light-emitting diode is detected as defective, and when at least one pixel around the defective pixel is a defect detection pixel, the controller may output a defect detection signal.

The sub-pixel may include a first transistor electrically connected between a first node of the driving transistor and the data line, and a second transistor electrically connected between a second node of the driving transistor and the sensing line, and a gate node of the first transistor and a gate node of the second transistor are connected to one gate line.

When the process for determining whether the organic light-emitting diode is defective is performed, the controller may change image data supplied to the data driving circuit when the sensing voltage sensed by the sensing circuit is less than a preset second comparison voltage value.

The process for determining whether the organic light-emitting diode is defective may include an initializing operation, a tracking operation, and a sampling operation.

The sub-pixel may include a first transistor electrically connected between a first node of the driving transistor and the data line, and a second transistor electrically connected between a second node of the driving transistor and the sensing line, and in the initializing operation, the tracking operation, and the sampling operation, a gate signal of a turn-on level may be applied to a gate node of the first transistor and a gate node of the second transistor.

According to one embodiment, there is provided a display apparatus including a display panel on which a plurality of sub-pixels are arranged, each of the plurality of sub-pixels including an organic light-emitting diode and a driving transistor for driving the organic light-emitting diode, a plurality of sensing lines disposed on the display panel, a sensing circuit configured to sense voltages of the plurality of sensing lines, and a controller configured to determine whether the organic light-emitting diode is defective based on pre-stored reference data, wherein the reference data is updated based on data acquired by a mobility sensing process of the driving transistor, which is performed in real time during display driving.

The update of the reference data may be performed before the display apparatus is completely turned off after the power-off signal is generated.

The controller may perform defect detection of the organic light-emitting diode based on the reference data stored before last power-off after a last power-off signal is generated.

The controller may include a memory configured to store the reference data, and a comparator configured to calculate the reference range based on the reference data, compare a slope of a waveform of the sensed voltage with a reference range, and output a defect detection signal of the organic light-emitting diode.

A process for determining whether the organic light-emitting diode is defective may be performed before an off-sensing process after a power-off signal is generated.

According to the display apparatus according to the embodiments, it is possible to omit the components for detecting a short circuit of the driving transistor and/or the organic light-emitting diode, for example, a detection circuit, a switching element, etc. and simplify the structure of the display apparatus by being also used for detecting the component for sensing the characteristic value of the driving transistor.

According to the display apparatus according to the embodiments, it is possible to separately detect the degradation of the characteristic value of the driving transistor and short circuits of the driving transistor and/or the organic light-emitting diode using the result of detecting the characteristic value of the previous driving transistor.

According to the display apparatus according to the embodiments, it is possible to detect both short circuits of the driving transistor and/or the organic light-emitting diode in one process.

According to the display apparatus according to the embodiments, it is possible to separately detect a short circuit of the driving transistor and a short circuit of the organic light-emitting diode in one process.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a schematic view illustrating a display apparatus according to embodiments of the present disclosure.

FIG. 2 is a systematic exemplary view of the display apparatus according to the embodiments of the present disclosure.

FIG. 3 is an example view of a circuit constituting a sub-pixel in the display apparatus according to the embodiments of the present disclosure.

FIG. 4 is a view illustrating an example circuit structure for sensing a characteristic value of a driving transistor in the display apparatus according to the embodiments of the present disclosure.

FIG. 5 is a view illustrating a driving timing diagram for sensing a threshold voltage among characteristic values of the driving transistor in the display apparatus according to the embodiments of the present disclosure.

FIG. 6 is a view illustrating a driving timing diagram for sensing mobility among the characteristic values of the driving transistor in the display apparatus according to the embodiments of the present disclosure.

FIG. 7 is a view illustrating a sensing process that may be performed at various timings in the display apparatus according to the embodiments of the present disclosure.

FIG. 8 is an arrangement diagram of four sub-pixels and peripheral lines thereof that may be connected to one sensing line in the display apparatus according to the embodiments of the present disclosure.

FIG. 9 is an equivalent circuit diagram of four sub-pixels that may be connected to one sensing line in the display apparatus according to the embodiments of the present disclosure.

FIG. 10 is a view illustrating detecting a short circuit that occurs in a driving voltage line in a display apparatus according to a comparative example.

FIG. 11 is a view illustrating a time point at which a defect of an organic light-emitting diode according to a first embodiment of the present disclosure is detected.

FIG. 12 is a view illustrating a driving timing diagram for defect detection of the organic light-emitting diode according to the first embodiment of the present disclosure.

FIG. 13 is a view illustrating defect detection and luminance control of the organic light-emitting diode according to the first embodiment of the present disclosure.

FIG. 14 is a view illustrating update of reference data according to the first embodiment of the present disclosure.

FIG. 15 is a view illustrating detecting defects of a driving transistor and/or an organic light-emitting diode according to a second embodiment of the present disclosure.

FIG. 16 is a view illustrating a driving timing diagram for detecting defects of a driving transistor and/or an organic light-emitting diode according to a third embodiment of the present disclosure.

FIG. 17 is a view illustrating a defect detection process of a driving transistor and/or an organic light-emitting diode according to the third embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Hereinafter, some embodiments of the present disclosure will be described in detail with reference to example drawings. In adding reference numerals to components in each drawing, the same components may have the same reference numerals as much as possible even when they are shown in different drawings. In addition, in the description of the present disclosure, when it is determined that the detailed description of a related known configuration or function may obscure the gist of the present specification, the detailed description thereof may be omitted. When terms “comprise,” “have,” “consist of,” etc. described in the present specification are used, other parts may be added unless “only” is used. When a component is expressed in the singular, it may include a case where the component is provided as a plurality of components unless specifically stated otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, the terms such as “display panel on which,” “display panel in which,” and “display panel at which” may be used interchangeably and may refer to each other. In one or more aspects, the terms such as “on the display panel,” “in the display panel” and at the display panel” may be used interchangeably and may refer to each other.

In addition, in the description of the components of the present disclosure, terms such as first, second, A, B, (a), and (b) may be used. These terms are only for the purpose of distinguishing one component from another component, and the nature, sequence, order, etc. of the corresponding component is not limited by these terms.

In the description of the positional relationship of components, when two or more components are described as being “connected,” “coupled,” or “joined,” it should be understood that the two or more components are directly “connected,” “coupled,” or “joined,” but two or more components may be “connected,” “coupled,” or “joined” with other components “interposed” therebetween. Here, other components may be included in one or more of the two or more components that are “connected,” “coupled,” or “joined.”

In the description of the temporal flow relationship related to components, operation methods, manufacturing methods, etc., for example, the temporal sequence relationship or the flow sequence relationship, such as “after,” “subsequent to,” “then,” or “before,” it may also include a non-continuous case unless “immediately” or “directly” is used.

Meanwhile, in case that numerical values of components or the corresponding information (e.g., a level) are described, even when there is no separate explicit description, the numerical values or the corresponding information can be construed as including a range of error that may occur due to various factors (e.g., process factors, an internal or external impact, and noise).

Hereinafter, various embodiments of the present disclosure will be described in detail with reference to the accompanying drawings.

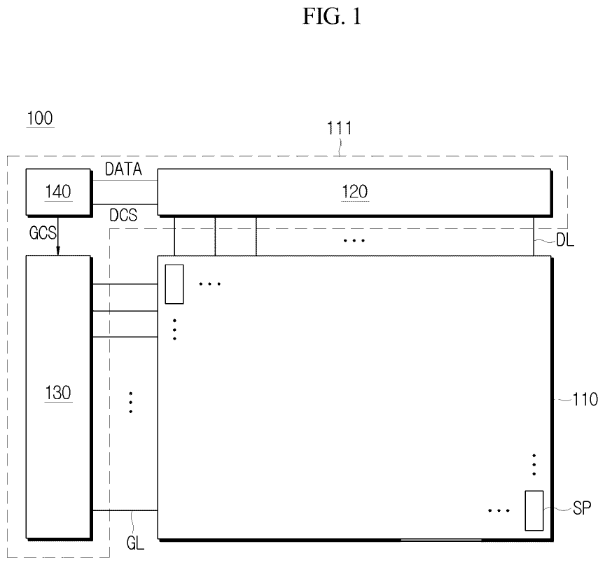

FIG. 1 is a schematic view illustrating a display apparatus according to embodiments of the present disclosure.

Referring to FIG. 1, a display apparatus 100 according to the present embodiments may include a display panel 110 in which a plurality of data lines DL and a plurality of gate lines GL are disposed, and a plurality of sub-pixels SP defined by the plurality of data lines DL and the plurality of gate lines GL are arranged in a matrix type, and a driving circuit 111 for driving the display panel 110.

The driving circuit 111 may include a data driving circuit 120 for driving the plurality of data lines DL, a gate driving circuit 130 for driving the plurality of gate lines GL, a controller 140 for controlling the data driving circuit 120 and the gate driving circuit 130, etc.

On the display panel 110, the plurality of data lines DL and the plurality of gate lines GL may be disposed to intersect each other. For example, the plurality of gate lines GL may be arranged in rows or columns, and the plurality of data lines DL may be arranged in columns or rows. Hereinafter, for convenience of description, it is assumed that the plurality of gate lines GL are disposed in rows and the plurality of data lines DL are disposed in columns.

In the display panel 110, other types of lines in addition to the plurality of data lines DL and the plurality of gate lines GL may be disposed.

The controller 140 may supply image data DATA to the data driving circuit 120.

In addition, the controller 140 may supply various control signals DCS and GCS required for the driving operation of the data driving circuit 120 and the gate driving circuit 130 and control the operation of the data driving circuit 120 and the gate driving circuit 130.

The controller 140 may start scanning according to the timing implemented in each frame, convert externally received image data into a data signal format used in the data driving circuit 120, output the converted image data DATA, and control data driving at a proper time according to scanning.

To control the data driving circuit 120 and the gate driving circuit 130, the controller 140 may receive timing signals, such as a vertical synchronization signal Vsync, a horizontal synchronization signal Hsync, an input data enable DE signal, a clock signal CLK, etc. from the outside (e.g., a host system), generate various control signals, and output the generated control signals to the data driving circuit 120 and the gate driving circuit 130.

For example, to control the gate driving circuit 130, the controller 140 may output various gate control signals GCS including a gate start pulse (GSP), a gate shift clock (GSC), a gate output enable signal (GOE), etc.

In addition, to control the data driving circuit 120, the controller 140 may output various data control signals DCS including a source start pulse SSP, a source sampling clock SSC, a source output enable signal SOE, etc.

The controller 140 may be a timing controller used in a typical display technology or a control device capable of further performing other control functions as well as the timing controller.

The controller 140 may be implemented as a component separately from the data driving circuit 120 or implemented as an integrated circuit by being integrated with the data driving circuit 120.

The data driving circuit 120 drives the plurality of data lines DL by receiving the image data DATA from the controller 140 and supplying data voltages to the plurality of data lines DL. Here, the data driving circuit 120 is also referred to as a source driving circuit.

The data driving circuit 120 may include a shift register, a latch circuit, a digital to analog converter DAC, an output buffer, etc.

The data driving circuit 120 may further include one or more analog to digital converters ADCs in some cases.

The gate driving circuit 130 may sequentially drive the plurality of gate lines GL by sequentially supplying the scan signals to the plurality of gate lines GL. Here, the gate driving circuit 130 is also referred to as a scan driving circuit.

The gate driving circuit 130 may include a shift register, a level shifter, etc.

The gate driving circuit 130 may sequentially supply the scan signal SCAN of an on voltage or an off voltage to the plurality of gate lines GL under the control of the controller 140.

When a specific gate line GL is opened by the gate driving circuit 130, the data driving circuit 120 may convert the image data DATA received from the controller 140 into analog data voltages and supply the analog data voltages to the plurality of data lines DL.

The data driving circuit 120 may be located at only one side (e.g., an upper or lower side) of the display panel 110 and in some cases, may be located at both sides (e.g., the upper and lower sides) of the display panel 110 according to a driving method, a panel design method, etc.

The gate driving circuit 130 may be located at only one side (e.g., a left or right side) of the display panel 110 and in some cases, may be located at both sides (e.g., the left and right sides) of the display panel 110 according to a driving method, a panel design method, etc.

The data driving circuit 120 may be implemented by including at least one source driver integrated circuit SDIC.

Each source driver integrated circuit SDIC may be connected to a bonding pad of the display panel 110 by a tape automated bonding (TAB) method or a chip on glass (COG) method or may be directly disposed on the display panel 110. In some cases, each source driving integrated circuit SDIC may be disposed integrally with the display panel 110. In addition, the gate driving circuit 130 may be implemented by a chip on film (COF) method. In this case, each gate driver integrated circuit GDIC may be mounted on a circuit film and electrically connected to the data lines DL of the display panel 110 through the circuit film.

The gate driving circuit 130 may have one or more gate driver integrated circuits GDIC connected to the bonding pad of the display panel 110 by a TAB method or a COG method. In addition, the gate driving circuit 130 may be implemented by a COF method. In this case, each gate driver integrated circuit GDIC included in the gate driving circuit 130 may be mounted on a circuit film and electrically connected to the gate lines GL of the display panel 110 through the circuit film. In addition, the gate driving circuit 130 may be implemented in a gate in panel (GIP) type and may be directly disposed on the display panel 110.

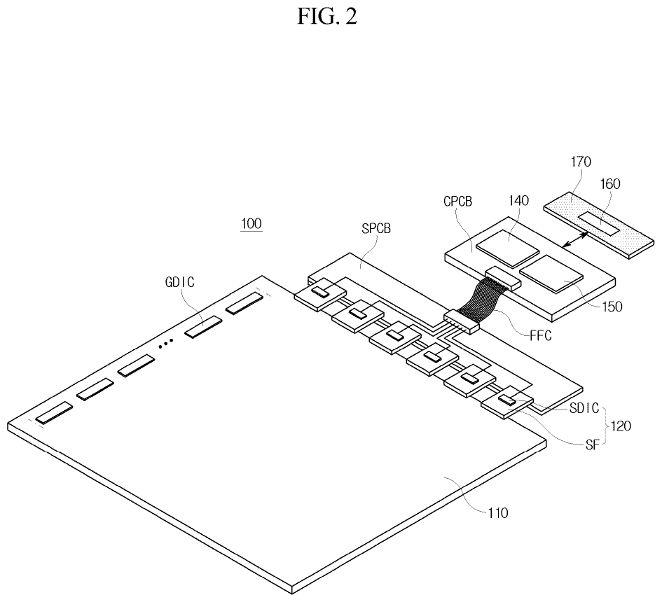

FIG. 2 is a systematic example view of the display apparatus according to the embodiments of the present disclosure.

The example of FIG. 2 is a case in which each source driver integrated circuit SDIC included in the data driving circuit 120 is implemented by a COF method among various methods (e.g., a TAB, a COG, a COF, etc.), and the gate driving circuit 130 is implemented in a GIP type among various methods (e.g., a TAB, a COG, a COF, a GIP, etc.).

Each of the plurality of source driver integrated circuits SDIC included in the data driving circuit 120 may be mounted on a source-side circuit film SF.

One side of the source-side circuit film SF may be electrically connected to the display panel 110.

On the source-side circuit film SF, lines for electrically connecting the source driver integrated circuits SDICs to the display panel 110 may be disposed.

The display apparatus 100 may include at least one source printed circuit board SPCB for circuit-connecting the plurality of source driver integrated circuits SDICs to other devices, and a control printed circuit board CPCB for mounting control components and various electrical devices.

The other side of the source-side circuit film SF on which the source driver integrated circuit SDIC is mounted may be connected to at least one source printed circuit board SPCB.

That is, the source-side circuit film SF on which the source driver integrated circuit SDIC is mounted may have one side electrically connected to the display panel 110 and the other side electrically connected to the source printed circuit board SPCB.

The control printed circuit board CPCB may be provided with the controller 140 for controlling the operation of the data driving circuit 120, the gate driving circuit 130, etc., a power management IC (PMIC) 150 for supplying various voltages or currents to the display panel 110, the data driving circuit 120, the gate driving circuit 130, etc. or controlling various voltages or currents to be supplied, etc.

The at least one source printed circuit board SPCB and the control printed circuit board CPCB may be circuit-connected through at least one connection member. Here, the connection member may be, for example, a flexible printed circuit (FPC), a flexible flat cable (FFC), etc.

The at least one source printed circuit board SPCB and the control printed circuit board CPCB may be implemented integrally with one printed circuit board.

The display apparatus 100 may further include a set board 170 electrically connected to the control printed circuit board CPCB. The set board 170 may also be referred to as a power board.

The set board 170 may be provided with a main power management circuit (M-PMC) 160 for managing the overall power of the display apparatus 100.

The PMIC 150 is a circuit for managing the power of a display module including the display panel 110, the driving circuits 120, 130, and 140, etc., and the M-PMC 160 is a circuit for managing the overall power including the display module and may be lined with the PMIC 150.

Each sub-pixel SP arranged on the display panel 110 may be composed of a circuit element, such as an organic light-emitting diode (OLED) that is a self-light-emitting element, a driving transistor DRT for driving the OLED, etc.

The types and number of circuit elements constituting each sub-pixel SP may be determined in various ways according to the provided functions, design method, etc.

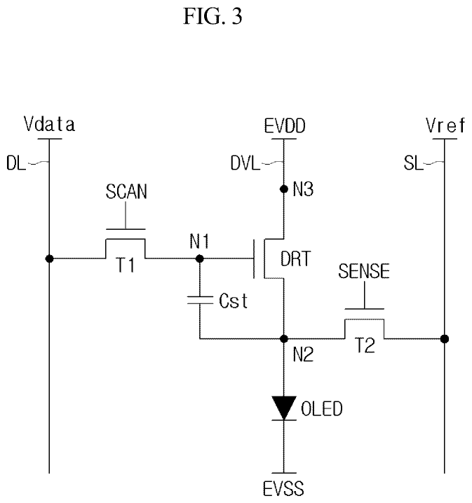

FIG. 3 is an example view of a circuit constituting a sub-pixel in the display apparatus according to the embodiments of the present disclosure.

On the display panel 110, the plurality of data lines DL, the plurality of gate lines GL, a plurality of driving voltage lines DVLs, a plurality of sensing lines SL, etc. may be disposed.

Each sub-pixel SP may include an OLED, the driving transistor DRT for driving the OLED, a first transistor T1 electrically connected between a first node N1 of the driving transistor DRT and the corresponding data line DL, a second transistor T2 electrically connected between a second node N2 of the driving transistor DRT and the corresponding sensing line SL among the plurality of sensing lines SL, a storage capacitor Cst electrically connected between the first node N1 and the second node N2 of the driving transistor DRT, etc.

The OLED may be composed of an anode electrode, an organic light-emitting layer, a cathode electrode, etc.

Referring to the example circuit of FIG. 3, the anode electrode of the OLED may be electrically connected to the second node N2 of the driving transistor DRT. A base voltage EVSS may be applied to the cathode electrode of the OLED.

Here, the base voltage EVSS may be, for example, a ground voltage or a higher or lower voltage than the ground voltage. In addition, the base voltage EVSS may be changed according to a driving state. For example, the base voltage EVSS during image driving and the base voltage EVSS during sensing driving may be set differently.

The driving transistor DRT drives the OLED by supplying a driving current to the OLED.

The driving transistor DRT may include the first node N1, the second node N2, a third node N3, etc.

The first node N1 of the driving transistor DRT may be a gate node and may be electrically connected to a source node or drain node of the first transistor T1. The second node N2 of the driving transistor DRT may be a source node or a drain node, electrically connected to the anode electrode (or the cathode electrode) of the OLED, and electrically connected to a source node or drain node of the second transistor T2. The third node N3 of the driving transistor DRT may be a drain node or a source node, may receive a driving voltage EVDD, and may be electrically connected to a driving voltage line DVL to which the driving voltage EVDD is supplied. Hereinafter, for convenience of description, an example in which, in the driving transistor DRT, the first node N1 is a gate node, the second node N2 is a source node, and the third node N3 is a drain node may be described.

The storage capacitor Cst may be electrically connected between the first node N1 and the second node N2 of the driving transistor DRT to maintain a data voltage Vdata corresponding to an image signal voltage or a voltage corresponding thereto for one frame time (or a set time).

The drain node or source node of the first transistor T1 may be electrically connected to the corresponding data line DL, the source node or drain node of the first transistor T1 may be electrically connected to the first node N1 of the driving transistor DRT, and the gate node of the first transistor T1 may be electrically connected to the corresponding gate line GL to receive the scan signal SCAN.

The first transistor T1 may be controlled to be turned on and off by receiving the scan signal SCAN at the gate node through the corresponding gate line GL. The first transistor T1 may also be referred to as a switching transistor.

The first transistor T1 may be turned on by the scan signal SCAN to transmit the data voltage Vdata supplied from the corresponding data line DL to the first node N1 of the driving transistor DRT.

The drain node or source node of the second transistor T2 may be electrically connected to the sensing line SL, and the source node or drain node of the second transistor T2 may be electrically connected to the second node N2 of the driving transistor DRT. The gate node of the second transistor T2 may be electrically connected to the corresponding gate line GL to receive a sense signal SENSE.

The second transistor T2 may be controlled to be turned on and off by receiving the sense signal SENSE at the gate node through the corresponding gate line GL. The second transistor T2 may also be referred to as a sensing transistor.

The second transistor T2 may be turned on by the sense signal SENSE to transmit a reference voltage Vref supplied from the corresponding sensing line SL to the second node N2 of the driving transistor DRT.

The driving transistor DRT, the first transistor T1, and the second transistor T2 may each be an n-type transistor or a p-type transistor.

Meanwhile, the scan signal SCAN and the sense signal SENSE may be the same gate signal. In this case, the gate signal SCAN and the sense signal SENSE may be commonly applied to the gate node of the first transistor T1 and the gate node of the second transistor T2 through the same gate line. That is, the gate nodes of the first and second transistors may be connected to one gate line GL. In this case, an aperture ratio of the sub-pixel SP can be improved. Hereinafter, such a structure is referred to as a “one scan type” sub-pixel circuit.

In some cases, the scan signal SCAN and the sense signal SENSE may be separate gate signals. In this case, the gate signal SCAN and the sense signal SENSE may be commonly applied to the gate node of the first transistor T1 and the gate node of the second transistor T2 through different gate lines.

A structure of each sub-pixel SP illustrated in FIG. 3 has a 3T (transistor) 1C (capacitor) structure, which is only an example for description, and the structure of the sub-pixel may further include one or more transistors or in some cases, may further include one or more capacitors. Alternatively, each of the plurality of sub-pixels SP may have the same structure, or some of the plurality of sub-pixels SP may have different structures.

Hereinafter, an example of an image driving operation of each sub-pixel SP will be briefly described.

A display driving (also referred to as image driving) operation of each sub-pixel SP may include an image data DATA writing operation, a boosting operation, and a light-emitting operation.

In the image data DATA writing operation, the image driving data voltage Vdata that corresponds to an image signal may be applied to the first node N1 of the driving transistor DRT, and the image driving reference voltage Vref may be applied to the second node N2 of the driving transistor DRT. Here, due to a resistance component etc. between the second node N2 of the driving transistor DRT and the sensing line SL, a voltage Vref similar to the reference voltage Vref may be applied to the second node N2 of the driving transistor DRT.

The image driving reference voltage Vref is also referred to as VpreR.

In the image data DATA writing operation, the first transistor T1 and the second transistor T2 may be turned on simultaneously or with a slight time difference.

In the image data DATA writing operation, the storage capacitor Cst may be charged with charges corresponding to a potential difference (Vdata-Vref or Vdata-Vref) between both ends thereof.

When the image driving data voltage Vdata is applied to the first node N1 of the driving transistor DRT, it is referred to as “image data DATA writing.”

In the boosting operation following the image data DATA writing operation, the first node N1 and the second node N2 of the driving transistor DRT may be electrically floated simultaneously or with a slight time difference.

To this end, the first transistor T1 may be turned off by a turn-off level voltage of the scan signal SCAN. In addition, the second transistor T2 may be turned off by a turn-off level voltage of the sense signal SENSE.

In the boosting operation, while a voltage difference between the first node N1 and the second node N2 of the driving transistor DRT is maintained, a voltage of each of the first node N1 and the second node N2 of the driving transistor DRT may be boosted.

During the boosting operation, when the voltage of each of the first node N1 and the second node N2 of the driving transistor DRT is boosted and then the increased voltage of the second node N2 of the driving transistor DRT is higher than or equal to a predetermined voltage (i.e., a voltage capable of turning on the OLED and a voltage higher than the base voltage EVSS by a threshold voltage of the OLED), the light-emitting operation may proceed.

In the light-emitting operation, a driving current may flow to the OLED, and the OLED may emit light.

The driving transistor DRT disposed in each of the plurality of sub-pixels SP may have unique characteristic values, such as a threshold voltage, mobility (also referred to as electron mobility), etc.

The driving transistor DRT may be degraded according to a driving time. Accordingly, the unique characteristic values of the driving transistor DRT may vary according to the driving time.

The on-off timing of the driving transistor DRT or the driving capability of the OLED may vary according to changes in characteristic values. That is, the driving transistor DRT may have the timing of a current supplied to the OLED and the amount of the current supplied to the OLED that vary according to the changes in characteristic values. According to the changes in characteristic values of the driving transistor DRT, an actual luminance of the corresponding sub-pixel SP may differ from a desired luminance.

In addition, the plurality of sub-pixels SP arranged on the display panel 110 may have different driving times. Accordingly, a characteristic value deviation (a threshold voltage deviation or a mobility deviation) between the driving transistors DRT in the sub-pixels SP may occur.

The characteristic value deviation between the driving transistors DRT may cause a luminance deviation between the sub-pixels SP. Accordingly, the luminance uniformity of the display panel 110 can be also degraded, eventually leading to the degradation of image quality.

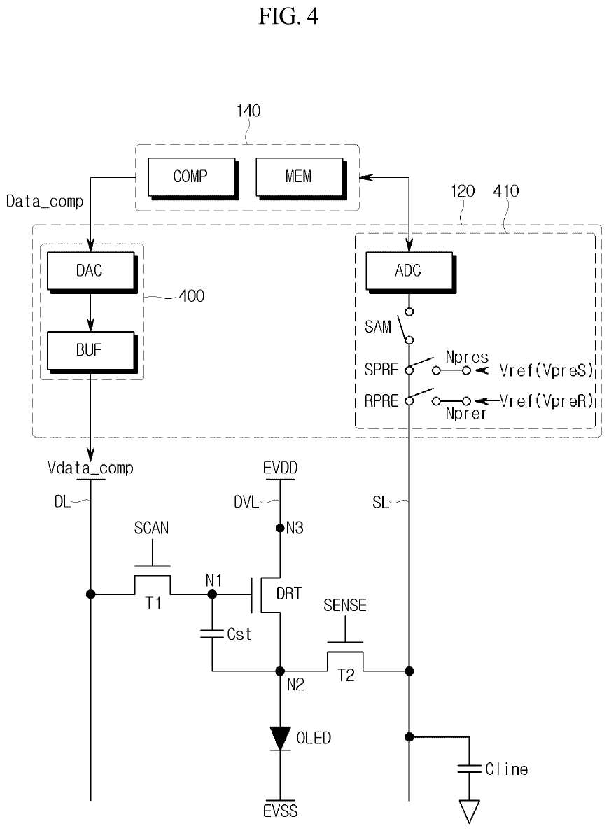

The display apparatus 100 according to the embodiments of the present disclosure may include a compensation circuit for compensating for a characteristic value deviation between driving transistors DRT and provide a compensation method using the same. This will be described in more detail with reference to FIGS. 4 to 7.

FIG. 4 is a view illustrating an example circuit structure for sensing a characteristic value of a driving transistor in the display apparatus according to the embodiments of the present disclosure.

To compensate for the characteristic value deviation between the driving transistors DRT, the display apparatus 100 according to the embodiments of the present disclosure may sense the characteristic values or changes in characteristic values of each driving transistor DRT.

The compensation circuit of the display apparatus 100 according to the embodiments of the present disclosure may include a sensing circuit 410 for sensing the characteristic values or the changes in characteristic values of the driving transistor DRT in the sub-pixel SP by driving (performing sensing driving on) the sub-pixel SP having a 3T1C structure or a structure modified based on this.

In the present specification, for convenience of description, “sensing the characteristic values or the changes in characteristic values of the driving transistor DRT in the sub-pixel SP” is also referred to as “sensing the sub-pixel SP.” In addition, “compensating for the characteristics or the changes in characteristic values of the driving transistor DRT in the sub-pixel SP” is also referred to as “compensating for the sub-pixel SP.”

The display apparatus 100 according to the embodiments of the present disclosure may sense a voltage of the sensing line SL through sensing driving and identify the characteristic values or the changes in characteristic values of the driving transistor DRT in the sub-pixel SP from the sensed voltage. Here, the sensing line SL may serve as a sensing line for transmitting the reference voltage Vref and sensing characteristics (e.g., characteristic values of the driving transistor DRT) of the sub-pixel. Accordingly, the sensing line SL may also be referred to as a reference voltage line because it also serves to transmit the reference voltage Vref.

More specifically, according to the sensing driving of the display apparatus 100 according to the embodiments of the present disclosure, the characteristic values or changes in characteristic values of the driving transistor DRT are reflected in the voltage (e.g., Vdata-Vth) of the second node N2 of the driving transistor DRT.

When the second transistor T2 is turned on, the voltage of the second node N2 of the driving transistor DRT may correspond to the voltage of the sensing line SL. A line capacitor Cline disposed on the sensing line SL may be charged by the voltage of the second node N2 of the driving transistor DRT. Due to the charged line capacitor Cline, the sensing line SL may have a voltage corresponding to the voltage of the second node N2 of the driving transistor DRT.

The compensation circuit of the display apparatus 100 according to the embodiments of the present disclosure may be driven so that the second node N2 of the driving transistor DRT becomes a voltage state that reflects the characteristic values (a threshold voltage and mobility) or the changes in characteristic values of the driving transistor DRT through the on-off control of each of the first transistor T1 and the second transistor T2 in the sub-pixel SP, which will be sensed, and the supply control of each of the data voltage Vdata and the reference voltage Vref.

Referring to FIG. 4, the display apparatus 100 according to the embodiments of the present disclosure may include the sensing circuit 410 for sensing a plurality of sensing lines SL.

The sensing circuit 410 may include an analog-to-digital converter ADC for sensing the voltage of the sensing line SL corresponding to the voltage of the second node N2 of the driving transistor DRT and converting the sensed voltage into the sensing value corresponding to a digital value and sensing driving switching circuits SAM and SPRE and an image driving reference switch RPRE.

The sensing circuit 410 may be present outside the data driving circuit 120 (e.g., a PCB), but included inside the data driving circuit 120.

The sensing driving switch circuits SAM and SPRE may control the voltage state of the corresponding sensing line SL or control whether to connect the corresponding sensing line SL to the analog-to-digital converter ADC.

The sensing driving switch circuits SAM and SPRE may include a sensing driving reference switch SPRE that controls connection between each sensing line SL and a sensing driving reference voltage VpreS supply node Npres to which the reference voltage Vref is supplied and a sampling switch SAM for controlling connection between each sensing line SL and the analog-to-digital converter ADC.

The sensing driving reference switch SPRE is a switch used during sensing driving. The reference voltage Vref supplied to the sensing line SL by the sensing driving reference switch SPRE is a “sensing driving reference voltage VpreS.”

Meanwhile, referring to FIG. 4, the switch circuit may include the image driving reference switch RPRE used during image driving.

The image driving reference switch RPRE may control connection between each sensing line SL and an image driving reference voltage VpreR supply node Nprer to which the reference voltage Vref is supplied.

The image driving reference switch RPRE is a switch used during image driving. The reference voltage Vref supplied to the sensing line SL by the image driving reference switch RPRE is an “image driving reference voltage VpreR.”

The image driving reference switch RPRE and the image driving reference voltage VpreR may be used during sensing driving.

The sensing driving reference switch SPRE and the image driving reference switch RPRE may be provided separately or implemented integrally. The sensing driving reference voltage VpreS and the image driving reference voltage VpreR may be the same voltage value or different voltage values.

The compensation circuit of the display apparatus 100 according to the embodiments of the present disclosure may further include a memory MEM which stores a sensing value output from the analog-to-digital converter ADC or in which a reference sensing value is stored in advance, and a compensator COMP for comparing the sensing value stored in the memory MEM with the reference sensing value and calculating a compensation value that compensates for a characteristic value deviation.

The compensation value calculated by the compensator COMP may be stored in the memory MEM.

The controller 140 may change the image data DATA, which will be supplied to the data driving circuit 120, using the compensation value calculated by the compensator COM and output changed image data Data_comp to the data driving circuit 120.

Accordingly, the data driving circuit 120 may convert the changed image data Data_comp into a data voltage Vdata_comp in an analog signal form through a digital-to-analog converter DAC and output the converted data voltage Vdata_comp to the corresponding data line DL through an output buffer BUF. Accordingly, the characteristic value deviation (the threshold voltage deviation or the mobility deviation) of the driving transistor DRT of the corresponding sub-pixel SP may be compensated.

Meanwhile, referring to FIG. 4, the data driving circuit 120 may include a data voltage output circuit 400 including a latch unit, a digital-to-analog converter DAC, an output buffer BUF, etc. and in some cases, may further include the analog-to-digital converter ADC and various switches SAM, SPRE, and RPRE.

Alternatively, the analog-to-digital converter ADC and various switches SAM, SPRE, and RPRE may be located outside the data driving circuit 120 rather than inside the data driving circuit 120.

Referring to FIG. 4, the compensator COMP may be present outside the controller 140, but may be included inside the controller 140. In addition, the memory MEM may be located outside the controller 140 or implemented in the form of a register inside the controller 140.

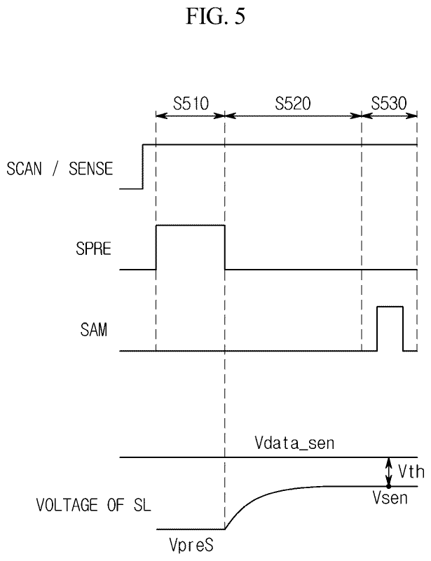

FIG. 5 is a view illustrating a driving timing diagram for sensing a threshold voltage among characteristic values of the driving transistor in the display apparatus according to the embodiments of the present disclosure.

Referring to FIG. 5, threshold voltage sensing driving (a threshold voltage sensing process) may include an initializing operation S510, a tracking operation S520, and a sampling operation S530.

In the initializing operation S510, the first transistor T1 is turned on by the scan signal SCAN of a turn-on level voltage. Accordingly, the first node N1 of the driving transistor DRT is initialized to the data voltage Vdata for threshold voltage sensing driving.

In the initializing operation S510, the second transistor T2 is turned on by the sense signal SENSE of a turn-on level voltage, and the sensing driving reference switch SPRE is turned on. Accordingly, the second node N2 of the driving transistor DRT is initialized to the sensing driving reference voltage VpreS.

The scan signal SCAN and the sense signal SENSE may be the same gate signal.

The tracking operation S520 is an operation of tracking a threshold voltage Vth of the driving transistor DRT. That is, the tracking operation S520 includes tracking the voltage of the second node N2 of the driving transistor DRT, which reflects the threshold voltage Vth of the driving transistor DRT.

In the tracking operation S520, the first transistor T1 and the second transistor T2 maintain the turned-on states, and the sensing driving reference switch SPRE is turned off. Accordingly, the second node N2 of the driving transistor DRT is floated, and the voltage of the second node N2 of the driving transistor DRT starts to rise from the sensing driving reference voltage VpreS.

Since the second transistor T2 is turned on, a rise in the voltage of the second node N2 of the driving transistor DRT leads to a rise in the voltage of the sensing line SL.

The voltage of the second node N2 of the driving transistor DRT rises and then is saturated. The saturated voltage of the second node N2 of the driving transistor DRT corresponds to a voltage difference (Vdata-Vth) between the data voltage Vdata for threshold voltage sensing driving and the threshold voltage Vth of the driving transistor DRT.

Accordingly, when the voltage of the second node N2 of the driving transistor DRT is saturated, the voltage of the sensing line SL corresponds to the voltage difference (Vdata-Vth) between the data voltage Vdata for threshold voltage sensing driving and the threshold voltage of the driving transistor DRT.

When the voltage of the second node N2 of the driving transistor DRT is saturated, the sampling switch SAM is turned on, and the sampling operation S530 proceeds.

In the sampling operation S530, the analog-to-digital converter ADC may sense the voltage of the sensing line SL connected by the sampling switch SAM and convert the sensed voltage Vsen into a sensing value corresponding to a digital value. Here, the voltage Vsen sensed by the analog-to-digital converter ADC corresponds to “Vdata-Vth.”

The compensator COMP may identify the threshold voltage of the driving transistor DRT of the corresponding sub-pixel SP based on the sensing value output from the analog-to-digital converter ADC and compensate for the identified threshold voltage of the driving transistor DRT.

The compensator COMP may identify the threshold voltage Vth of the driving transistor DRT from the sensing value (the digital value corresponding to (Vdata-Vth)) measured through sensing driving and the already known data (a digital value corresponding to Vdata) for threshold voltage sensing driving.

The compensator COMP may compare the identified threshold voltage Vth for the corresponding driving transistor DRT with the reference threshold voltage or a threshold voltage of another driving transistor DRT and compensate for a threshold voltage deviation between the driving transistors DRT. Here, the threshold voltage deviation compensation may mean image data change processing (processing of adding or subtracting a compensation value (offset) to or from the image data DATA).

Threshold voltage sensing may be performed using the image driving reference switch RPRE and the image driving reference voltage VpreR instead of the sensing driving reference switch SPRE and the sensing driving reference voltage VpreS.

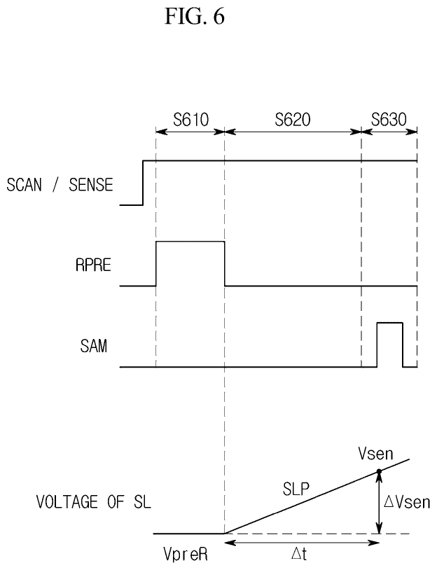

FIG. 6 is a view illustrating a driving timing diagram for sensing mobility among the characteristic values of the driving transistor in the display apparatus according to the embodiments of the present disclosure.

Referring to FIG. 6, mobility sensing driving (a mobility sensing process) may include an initializing operation S610, a tracking operation S620, and a sampling operation S630.

In the initializing operation S610, the first transistor T1 is turned on by the scan signal SCAN of a turn-on level voltage. Accordingly, the first node N1 of the driving transistor DRT is initialized to the data voltage Vdata for mobility sensing driving.

In the initializing operation S610, the second transistor T2 is turned on by the sense signal SENSE of a turn-on level voltage, and the sensing driving reference switch SPRE is turned on. Accordingly, the second node N2 of the driving transistor DRT is initialized to the sensing driving reference voltage VpreS.

The scan signal SCAN and the sense signal SENSE may be the same gate signal.

The tracking operation S620 is an operation of tracking the mobility of the driving transistor DRT. The mobility of the driving transistor DRT may refer to the current driving capability of the driving transistor DRT. That is, the tracking operation (S620), includes tracking the voltage of the second node N2 of the driving transistor DRT, at which the mobility of the driving transistor DRT may be calculated.

In the tracking operation S620, the first transistor T1 and the second transistor T2 maintain the turned-on states, and the sensing driving reference switch SPRE is turned off. Accordingly, the second node N2 of the driving transistor DRT is floated, and the voltage of the second node N2 of the driving transistor DRT starts to rise from the sensing driving reference voltage VpreS.

Since the second transistor T2 is turned on, a rise in the voltage of the second node N2 of the driving transistor DRT leads to a rise in the voltage of the sensing line SL.

When a predetermined time ΔT elapses from a time point at which the voltage of the second node N2 of the driving transistor DRT starts to rise, the sampling switch SAM is turned on, and the sampling operation S630 proceeds.

In the sampling operation S630, the analog-to-digital converter ADC may sense the voltage of the sensing line SL connected by the sampling switch SAM and convert the sensed voltage Vsen into a sensing value corresponding to a digital value. Here, the voltage Vsen sensed by the analog-to-digital converter ADC corresponds to a voltage (VpreS+ΔV) increased by a predetermined voltage ΔV from the sensing driving reference voltage VpreS.

As described above, mobility sensing may be performed using the sensing driving reference switch SPRE and the sensing driving reference voltage VpreS, but is not limited thereto. According to a design, mobility sensing may also be performed using the sensing driving reference switch SPRE and the sensing driving reference voltage VpreS.

The compensator COMP may identify the mobility of the driving transistor DRT of the corresponding sub-pixel SP based on the sensing value output from the analog-to-digital converter ADC and compensate for the identified mobility of the driving transistor DRT.

The compensator COMP may identify the mobility of the driving transistor DRT from the sensing value (the digital value corresponding to (VpreS+ΔV)) measured through sensing driving and the already known sensing driving reference voltage VpreS and elapsed time ΔT.

The mobility of the driving transistor DRT is proportional to a change in voltage per unit time (ΔV/Δt) of the sensing line SL in the tracking operation S620. That is, the mobility of the driving transistor DRT is proportional to a slope SLP of a waveform of the voltage of the sensing line SL in FIG. 6.

The compensator COMP may compare the mobility identified for the corresponding driving transistor DRT with a reference mobility or a mobility of another driving transistor DRT and compensate for a mobility deviation between the driving transistors DRT. Here, the mobility deviation compensation may mean image data change processing (processing of multiplying the image data DATA by a compensation value (gain)).

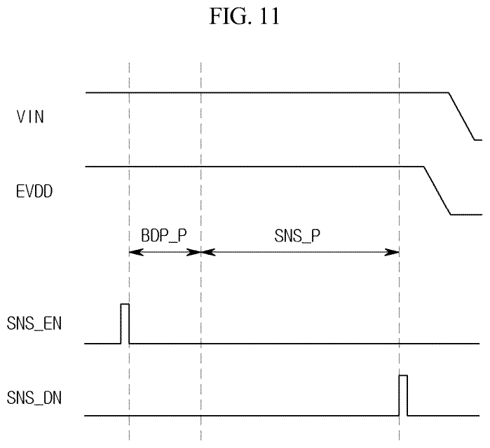

The display apparatus 100 according to the embodiments of the present disclosure may detect defects of the driving transistor DRT and/or the OLED using the process of sensing the mobility of the driving transistor DRT. This will be described below with reference to FIGS. 11 to 14.

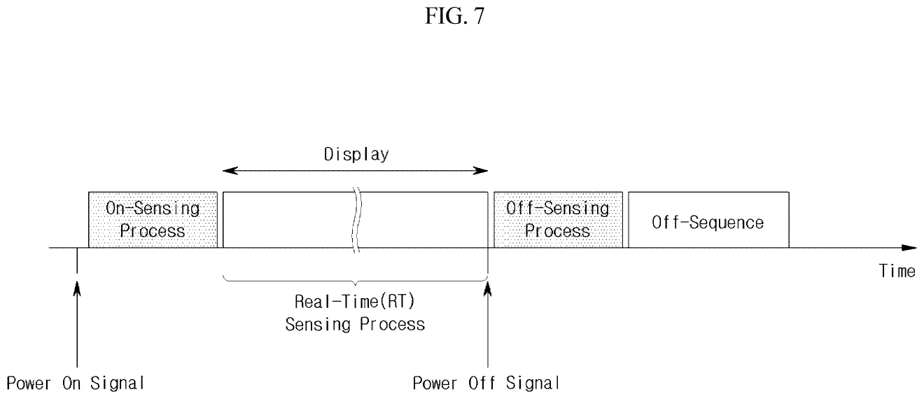

FIG. 7 is a view illustrating a sensing process that may be performed at various timings in the display apparatus according to the embodiments of the present disclosure.

Referring to FIG. 7, when a power-on signal is generated, the display apparatus 100 performs predetermined on-sequence processing for starting display driving, and when the on-sequence processing is completed, the display apparatus 100 starts to perform normal display driving.

When a power-off signal is generated, the display apparatus 100 stops the display driving in progress and performs predetermined off-sequence processing, and when the off-sequence processing is completed, the display apparatus 100 is completely turned off.

Sensing driving (threshold voltage sensing driving or mobility sensing driving) may be performed in relation to such a power processing timing. The sensing driving may be performed before display driving starts after the power-on signal is generated. The sensing and the sensing process are referred to as on-sensing and an on-sensing process.

In addition, the sensing driving may be performed after the power-off signal is generated. The sensing and the sensing process is referred to as off-sensing and an off-sensing process.

In addition, the sensing driving may be performed in real time during display driving. Such sensing process is referred to as a real-time (hereinafter referred to as RT) sensing process.

In the case of the RT sensing process, sensing driving may be performed on one or more sub-pixels SP in one or more sub-pixel lines (sub-pixel rows) per blank time during display driving.

When the sensing driving (the RT sensing driving) is performed for the blank time, the sub-pixel line (the sub-pixel row) on which sensing driving is performed may be selected randomly. Accordingly, it is possible to minimize the image abnormality phenomenon in the sub-pixel line subjected to sensing driving for an active time after the sensing driving for the blank time. In addition, a recovery data voltage corresponding to the data voltage before the sensing driving may be supplied to the sub-pixel SP subjected to the sensing driving for the active time after the sensing driving for the blank time. Accordingly, it is possible to further minimize the image abnormality phenomenon in the sub-pixel line subjected to the sensing driving for the active time after the sensing driving for the blank time.

Meanwhile, since the threshold voltage sensing driving requires a long time for the voltage at the second node N2 of the driving transistor DRT to be saturated, the threshold voltage sensing driving may be performed with the off-sensing process that may be performed for a slightly longer time.

Since the mobility sensing driving requires only a relatively short time compared to the threshold voltage sensing driving, the mobility sensing driving may be performed with the ON-sensing process and/or RT sensing process that are performed for a short time.

Although the threshold voltage sensing and/or the mobility sensing may be performed with the RT sensing process, hereinafter, for convenience of description, it is assumed that the mobility sensing is performed with the RT sensing process.

Meanwhile, one data voltage Vdata, two gate signals SCAN and SENSE, the reference voltage Vref, the driving voltage EVDD, etc. need to be supplied to one sub-pixel SP having the structure illustrated in FIG. 3. Accordingly, one sub-pixel SP may be electrically connected to one data line DL, one gate line GL or two gate lines GL, one sensing line SL, and one driving voltage line DVL (see FIG. 3).

To turn on and off one sub-pixel row, one gate line GL or two gate lines GL need to be disposed in each sub-pixel row. Hereinafter, an example in which one gate line GL is disposed in one sub-pixel row and the scan signal SCAN and the sense signal SENSE are transmitted through one gate line GL will be described.

In addition, since the data voltage Vdata needs to be supplied to each sub-pixel SP, one data line DL may be disposed in each sub-pixel column. In some cases, the one data line DL may be commonly disposed per two sub-pixel columns.

Since the driving voltage EVDD may be a common voltage, one driving voltage line DVL may be disposed in each sub-pixel column (or each sub-pixel row), and the one driving voltage line DVL may be disposed per two or more sub-pixel columns.

Likewise, since the reference voltage Vref may be a common voltage, one sensing line SL may be disposed in each sub-pixel column (or each sub-pixel row), and the one sensing line SL may be disposed per two or more sub-pixel columns (or two or more sub-pixel columns).

When one driving voltage line DVL and/or one sensing line SL are disposed per two or more sub-pixel columns (or two or more sub-pixel columns), it is possible to further increase an aperture ratio of the display panel 110.

For example, when the display panel 110 is composed of sub-pixels SP that emit four colors (red, green, blue, and white), one sensing line SL may be disposed per four sub-pixel columns. In this case, all sub-pixels SP included in the four sub-pixel columns may receive the reference voltage Vref from one sensing line SL or may be sensed through the one sensing line SL.

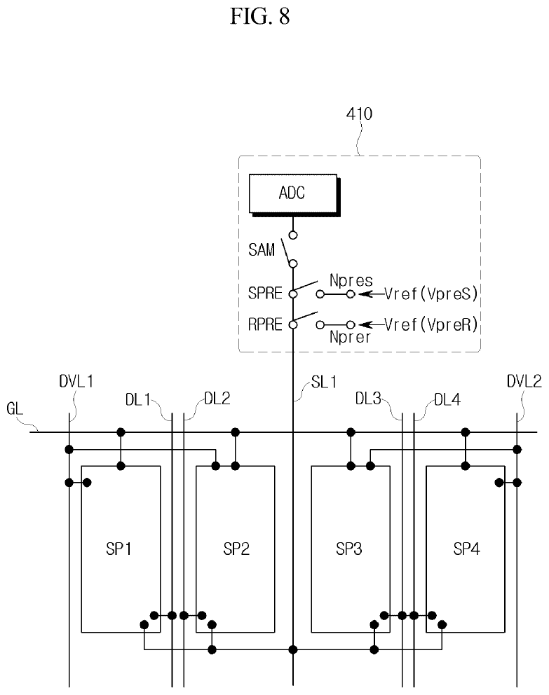

Hereinafter, to increase the aperture ratio of the display panel 110, a structure in which one driving voltage line DVL is disposed parallel to the data line DL per four or more sub-pixel columns, and one sensing line SL is disposed parallel to the data line DL per four or more sub-pixel columns will be described with reference to FIG. 8.

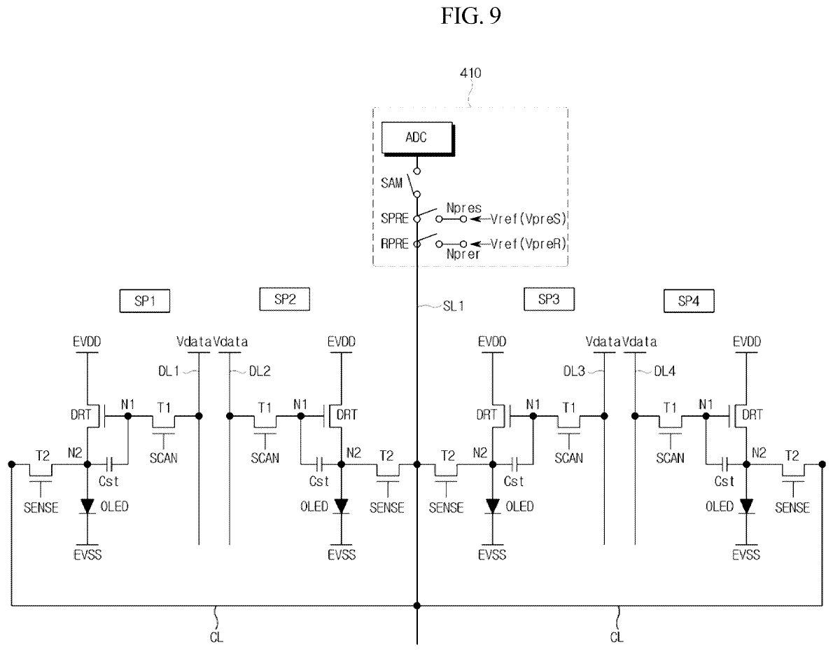

FIG. 8 is an arrangement diagram of four sub-pixels and peripheral lines thereof that may be connected to one sensing line in the display apparatus according to the embodiments of the present disclosure. FIG. 9 is an equivalent circuit diagram of four sub-pixels that may be connected to one sensing line in the display apparatus according to the embodiments of the present disclosure.

One sub-pixel row may include a plurality of sub-pixels SP, and among them, four sub-pixels SP1 to SP4 may be electrically connected to a first sensing line SL1 as illustrated in FIGS. 8 and 9.

The four sub-pixels SP1 to SP4 that emit different colors may form one pixel. For example, the four sub-pixels SP1 to SP4 that emit four colors (red, green, blue, and white), respectively, may form one pixel.

The four sub-pixels SP1 to SP4 may be sub-pixels SP that represent four sub-pixel columns, respectively. That is, a first sub-pixel SP1 may represent a first sub-pixel column, a second sub-pixel SP2 may represent the second sub-pixel column, a third sub-pixel SP3 may represent a third sub-pixel column, and a fourth sub-pixel SP4 may represent a fourth sub-pixel column. Accordingly, arrangement structures of FIGS. 8 and 9 may be expansively applied to the display panel 110.

According to the example of FIG. 8, it is assumed that the scan signal SCAN applied to the gate node of the first transistor T1 and the sense signal SENSE applied to the gate node of the second transistor T2, which are included in each of the four sub-pixels SP1 to SP4, are the same gate signals.

Accordingly, one gate line GLI for transmitting the scan signal SCAN and the sense signal SENSE to each of the four sub-pixels SP1 to SP4 included in one sub-pixel row may be disposed.

On the display panel 110, four data lines DL1 to DL4 for supplying the data voltage Vdata to the four sub-pixels SP1 to SP4, respectively, may be disposed.

A first data line DL1 and a second data line DL2 may be located between the first sub-pixel SP1 and the second sub-pixel SP2. A third data line DL3 and a fourth data line DL4 may be located between the third sub-pixel SP3 and the fourth sub-pixel SP4.

To increase the aperture ratio of the display panel 110, driving voltage lines DVL1 and DVL2 that transmit the driving voltage EVDD, which may be a common voltage, and the first sensing line SL1 that transmits the reference voltage Vref, which may be a common voltage, may be disposed in a shared structure.

That is, the driving voltage lines DVL1 and DVL2 are not disposed per sub-pixel column and may be disposed per a plurality of sub-pixel columns. The first sensing line SL1 is not disposed per sub-pixel column and may be disposed per a plurality of sub-pixel columns.

More specifically, the first sub-pixel SP1 and the second sub-pixel SP2 may commonly receive the driving voltage EVDD through a first driving voltage line DVL1. The third sub-pixel SP3 and the fourth sub-pixel SP4 may commonly receive the driving voltage EVDD through a second driving voltage line DVL2.

The source node or drain node of the second transistor T1 included in each of the first sub-pixel SP1, the second sub-pixel SP2, the third sub-pixel SP3, and the fourth sub-pixel SP4 may be commonly connected to the first sensing line SL1. Accordingly, the first to fourth sub-pixels SP1 to SP4 may commonly receive the reference voltage Vref through one first sensing line SL1.

Meanwhile, referring to FIGS. 8 and 9, as an example, one first sensing line SL1 may be disposed between the second sub-pixel SP2 and the third sub-pixel SP3. In this case, the first sub-pixel SP1 and the fourth sub-pixel SP4 may be connected to one first sensing line SL1 through a connection line CL. The connection line CL may be integrated with the first sensing line SL1, and located in contact with a different layer from the first sensing line SL1.

The data lines DL1 to DL4 may be disposed symmetrically with respect to one first sensing line SL1. The driving voltage lines DVL1 and DVL2 may be disposed symmetrically with respect to one first sensing line SL1.

Referring to FIGS. 8 and 9, the sensing circuit 410 may be connected to one first sensing line SL1. Accordingly, at one time point, only one sub-pixel SP among the four sub-pixels SP1 to SP4 may be sensed.

Meanwhile, as described above, the driving voltage line DVL may be disposed in each sub-pixel SP. The driving transistor DRT and the OLED may be connected to the driving voltage line DVL.

A short circuit may occur in the driving transistor DRT and the OLED due to a panel crack etc., and such defects may cause damage to the display panel 110 and/or image quality abnormality. For example, due to an overcurrent, the driving voltage line DVL may be short-circuited, or the burnt phenomenon in which the display panel 110 is burnt may occur. In addition, the output of the OLED may decrease, or the OLED may not emit light at all. In addition, an incorrect compensation value may cause image quality abnormality. Accordingly, sensing for short circuit detection of the driving transistor DRT and the OLED may be performed.

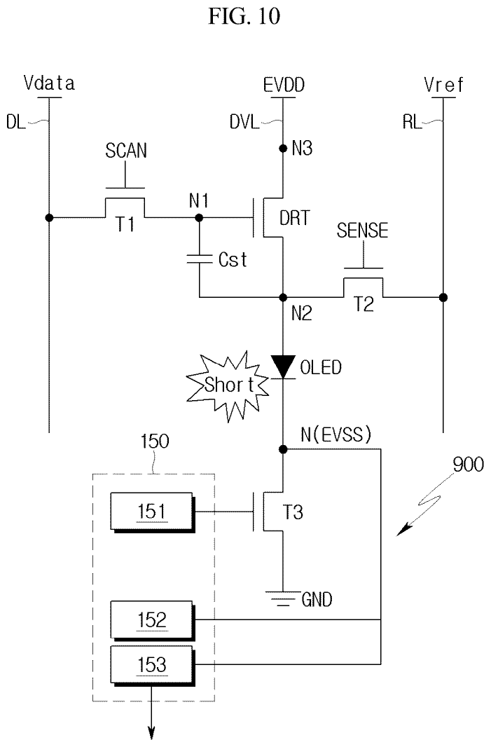

FIG. 10 is a view illustrating detecting a short circuit that occurs in a driving voltage line in a display apparatus according to a comparative example.

Referring to FIG. 10, the display apparatus 100 may further include a defect detection circuit 900 for detecting short circuits of elements disposed on the driving voltage line DVL.

The defect detection circuit 900 may include a third transistor T3, a switching control unit 151, a base voltage supply unit 152 for defect detection, and a defect sensing unit 153.

The third transistor T3 may be electrically connected to the cathode electrode of the OLED. The third transistor T3 may be an NMOS transistor. The third transistor T3 may electrically connect a base voltage node N(EVSS) to which the base voltage EVSS is applied to a ground GND or switch the base voltage node N(EVSS) to a floating state according to a control signal of the switching control unit 151.

The switching control unit 151 may control the switching of the third transistor T3 based on a voltage of the base voltage node N(EVSS), which is sensed by the defect sensing unit 153.

The base voltage supply unit 152 for defect detection may supply a defect detection base voltage to the base voltage node N(EVSS). For example, the defect detection base voltage may be substantially the same as the base voltage EVSS, and the base voltage supply unit 152 for defect detection may be a base voltage supply source, but the present disclosure is not limited thereto.

The defect sensing unit 153 may sense the voltage of the base voltage node N(EVSS) to detect a defect of the driving voltage line DVL and generate a defect detection signal BDP. The generated defect detection signal BDP may be transmitted to the switching control unit 151, and the switching control unit 151 may control the switching of the third transistor T3 based on the defect detection signal BDP.

The switching control unit 151, the base voltage supply unit 152 for defect detection, and the defect sensing unit 153 may be included in the PMIC 150. However, the present disclosure is not limited thereto, and the switching control unit 151, the base voltage supply unit 152 for defect detection, and the defect sensing unit 153 may be implemented as components separately from the PMIC 150.

Defect detection for a short circuit of the driving transistor DRT may be performed before the on-sensing process after the power-on signal is generated and/or before the off-sensing process after the power-off signal is generated.

When the defect detection for a short circuit of the driving transistor DRT is performed, the driving voltage EVDD may be applied to the third node N3 of the driving transistor DRT, and the scan signal SCAN and the sense signal SENSE may be applied at high levels to turn on the first and second transistors T1 and T2. A low level signal may be applied to the gate node of the third transistor T3, and the third transistor T3 may be turned off so that the base voltage node N(EVSS) may be floated.

In this case, the data voltage Vdata applied to the first node N1 of the driving transistor DRT may be a black data voltage (e.g., about 0 V) at which the driving transistor DRT is not turned on, and the voltage applied to the second node N2 of the driving transistor DRT through the second transistor T2 may be the image driving reference voltage VpreR supplied from the sensing line SL. In addition, the voltage applied to the base voltage node N(EVSS) may be the defect detection base voltage. For example, the driving voltage EVDD may be about 22 V, and the image driving reference voltage VpreR may range from about 1.5 to 2 V.

Defect detection base voltages, which are applied to the base voltage node N(EVSS) before the on-sensing process after the power-on signal is generated and before the off-sensing process after the power-off signal is generated, may be different. For example, the defect detection base voltage, which is applied to the base voltage node N(EVSS) before the on-sensing process after the power-on signal is generated, may be about 0 V, and the defect detection base voltage, which is applied to the base voltage node N(EVSS) before the off-sensing process after the power-off signal is generated, may be about 6.5 V.

The defect sensing unit 153 may generate the defect detection signal BDP when the voltage sensed at the base voltage node N(EVSS) is a preset reference voltage or higher. The preset reference voltage may be about 4.5 V when the defect detection is performed before the on-sensing process after the power-on signal is generated and may be about 8.5 V when the defect detection is performed before the off-sensing process after the power-off signal is generated.

The example in which a short circuit of the driving transistor DRT is detected using the image driving reference voltage VpreR has been described, but the present disclosure is not limited thereto. The sensing driving reference voltage VpreS may be used to detect a short circuit of the driving transistor DRT.

Referring further to FIG. 5, a short circuit of the OLED may be detected by a method similar to the threshold voltage sensing method of the driving transistor DRT. The short circuit of the OLED may be detected using the voltage Vsen acquired during the threshold voltage sensing of the driving transistor DRT. The short circuit detection of the OLED may be performed after the power-off signal is generated. However, the present disclosure is not limited thereto, and the short circuit detection of the OLED may be performed by a process separately from the threshold voltage sensing of the driving transistor DRT.

When a short circuit of the OLED is detected, the third transistor T3 may be turned off by the switching control unit 151 so that the base voltage node N(EVSS) is floated, and the defect detection base voltage may be applied to the base voltage node N(EVSS). A defect detection data voltage may be applied to the first node N1 of the driving transistor DRT, and the sensing driving reference voltage VpreS may be applied to the sensing line SL.

For example, the driving voltage EVDD may be about 22 V, the data voltage Vdata applied to the first node N1 of the driving transistor DRT may be about 4.5 V, the sensing driving reference voltage VpreS supplied to the sensing line SL may be about 0 V, and the defect detection base voltage may range from 0 V or 6.5 V. When the defect detection base voltage is set to a high voltage, for example, 6.5 V, the sub-pixel SP in which a short circuit occurs in the OLED can be prevented from being overcompensated and becoming a bright spot.

When the OLED is normal, the sensed voltage Vsen may be substantially the same as the defect detection data voltage. When a short circuit occurs in the OLED, the sensed voltage Vsen may differ from the defect detection data voltage. The controller 140 may determine that a short circuit has occurred in the OLED when a deviation between the preset reference voltage and the sensed voltage Vsen is a preset size or more.

The sensed voltage Vsen of the sub-pixel SP including the OLED in which a short circuit occurs may be lower than a sensed voltage Vsen of a neighboring sub-pixel SP. Meanwhile, as described above, the compensation value of each sub-pixel SP may be calculated based on the voltage Vsen sensed from each sub-pixel SP. Accordingly, the controller 140 may determine that an OLED of a specific sub-pixel SP is short-circuited when a difference between a compensation value of the specific sub-pixel SP and a compensation value of the neighboring sub-pixel SP is a preset threshold value or more.

The display apparatus 100 may perform various operations corresponding to the defect detection signal BDP, such as controlling the current of the driving voltage line DVL, controlling the luminance of the sub-pixel SP, or blocking the power of the display apparatus 100 based on the generated defect detection signal BDP.

For example, the defect detection signal BDP for a short circuit of the driving transistor DRT may be transmitted to the switching control unit 151 or the controller 140, and the switching control unit 151 or the controller 140 may turn off the third transistor T3 based on the received defect detection signal BDP to block a current path of the driving voltage line DVL. For another example, the defect detection signal BDP for the OLED may be transmitted to the controller 140, and the controller 140 may control the luminance of the sub-pixel SP in which a defect is detected by changing the image data DATA.

As described above, since the method of detecting short circuits of the driving transistor DRT and the OLED requires a separate circuit component (the defect detection circuit 900) including the third transistor T3, there is a disadvantage of having a complex structure and high manufacturing cost. In addition, the method of detecting a short circuit of an OLED using a difference between compensation values for compensating for threshold voltage has a disadvantage of a tight threshold voltage margin and a high possibility of false detection.

Hereinafter, a short detection method capable of eliminating the above disadvantages will be described with reference to FIGS. 11 to 14.

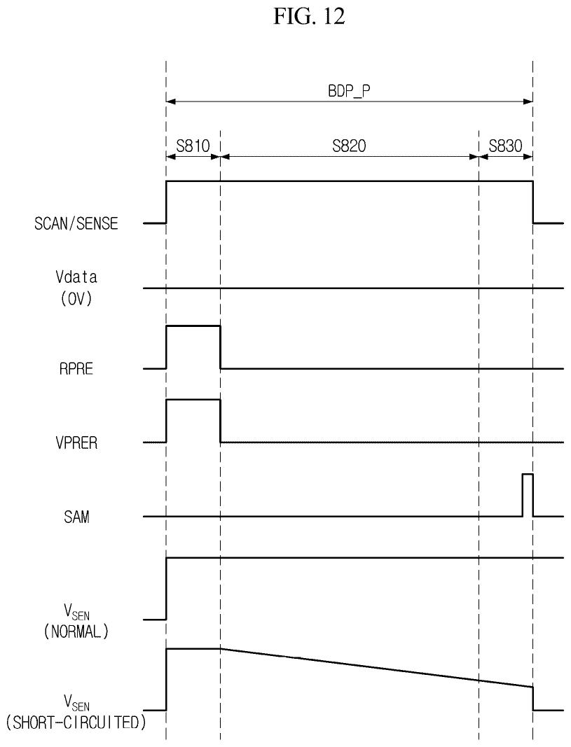

FIG. 11 is a view illustrating a time point at which a defect of an organic light-emitting diode according to a first embodiment of the present disclosure is detected. FIG. 12 is a view illustrating a driving timing diagram for defect detection of the organic light-emitting diode according to the first embodiment of the present disclosure.

Referring to FIG. 11, defect detection (short detection) of an OLED may be performed before an off-sensing process after a power-off signal is generated. For example, the off-sensing process may be a threshold voltage sensing driving. However, the present disclosure is not limited thereto, and the defect detection of the OLED may also be performed before the on-sensing process after the power-on signal is generated.

A defect detection process BDP_P of the OLED may be performed between the generation of an off-sensing enable signal and the generation of an off-sensing completion signal. When the off-sensing completion signal is generated, the supply of a DC input voltage VIN and the driving voltage EVDD may be blocked, and the display apparatus 100 may be turned off.

The controller 140 may control the gate driving circuit 130 and the data driving circuit 120 to perform the defect detection process BDP_P and a subsequent off-sensing process SNS_P of the OLED based on an off-sensing enable signal SNS_EN and an off-sensing completion signal SNS_DN that are received from the outside (e.g., a host system or a set product).

Referring to FIGS. 3, 4, 11, and 12, the defect detection process BDP_P of the OLED may sequentially perform an initializing operation S810, a tracking operation S820, and a sampling operation S830.

In the initializing operation S810, the tracking operation S820, and the sampling operation S830, the defect detection data voltage Vdata supplied to the data line DL may be a black data voltage that does not turn on the driving transistor DRT. For example, the black data voltage may be a ground voltage, that is, 0 V.

In the initializing operation S810, the first and second transistors T1 and T2 may be turned on by the scan signal SCAN and the sense signal SENSE of a turn-on level voltage. When the first and second transistors T1 and T2 are connected to one gate line GL, the scan signal SCAN and the sense signal SENSE may be the same gate signal. In addition, in the initializing operation S810, the image driving reference switch RPRE may be turned on, and the image driving reference voltage VpreR as a defect detection reference voltage may be applied to the sensing line SL.

For example, the image driving reference voltage VpreR used for defect detection of the OLED may range from about 3 V to 6 V, preferably, may be about 4.5 V. However, a magnitude of the image driving reference voltage VpreR is not limited thereto.

The threshold voltage sensing of the driving transistor DRT may be performed after the defect detection of the OLED. In this case, the magnitude of the image driving reference voltage VpreR used for the threshold voltage sensing of the driving transistor DRT may be set to be equal to a magnitude of the image driving reference voltage VpreR used for defect detection of the OLED. Accordingly, after the defect detection process BDP_P of the OLED is completed, the threshold voltage sensing process of the driving transistor DRT may be performed consecutively. For example, the initializing operation S810 may be omitted from the threshold voltage sensing process of the driving transistor DRT.

In the initializing operation S810, the first node N1 of the driving transistor DRT may be initialized to the defect detection data voltage Vdata, and the second node N2 of the driving transistor DRT may be initialized to the image driving reference voltage VpreR. When the second transistor T2 is turned on, the voltage of the second node N2 of the driving transistor DRT may correspond to the voltage of the sensing line SL. The line capacitor Cline disposed on the sensing line SL may be charged by the voltage of the second node N2 of the driving transistor DRT. Due to the charged line capacitor Cline, the sensing line SL may have a voltage corresponding to the voltage of the second node N2 of the driving transistor DRT.

After the line capacitor Cline is charged, the image driving reference switch RPRE may be turned off, and the tracking operation S820 may proceed.

In the tracking operation S820, the voltage of the second node N2 of the driving transistor DRT may be tracked. In the tracking operation S820, the first and second transistors T1 and T2 may maintain the turned-on states, and the image driving reference switch RPRE may maintain the turned-off state.

In the tracking operation S820, when the driving transistor DRT is normal, the voltages of the second node N2 of the driving transistor DRT and the sensing line SL may be maintained at predetermined levels. In this case, the voltage of the sensing line SL may be substantially the same as the image driving reference voltage VpreR.

In the tracking operation S820, when a short circuit occurs in the OLED, the voltage of the second node N2 of the driving transistor DRT may gradually decrease from the image driving reference voltage VpreR due to a leakage current caused by the short circuit. Since the second transistor T2 is turned on, the decrease in the voltage of the second node N2 of the driving transistor DRT may lead to a decrease in the voltage of the sensing line SL.

The voltage of the second node N2 of the driving transistor DRT may be the image driving reference voltage VpreR or lower. A magnitude of the voltage of the second node N2 of the driving transistor DRT may vary according to the degree to which the driving transistor DRT is short-circuited.

For example, when the OLED is normal, the voltage of the second node N2 of the driving transistor DRT may be substantially the same as the image driving reference voltage VpreR. That is, the voltages of the second node N2 and the sensing line SL may be constantly maintained as the image driving reference voltage VpreR. For another example, when the OLED is completely short-circuited, the voltage of the second node N2 of the driving transistor DRT may be substantially the same as the base voltage EVSS.

When the voltage of the second node N2 of the driving transistor DRT is saturated, the sampling switch may be turned on, and the sampling operation S830 may proceed.

In the sampling operation S830, the analog-to-digital converter ADC may sense the voltage of the sensing line SL connected by the sampling switch SAM and convert the sensed voltage Vsen into a sensing value corresponding to a digital value.

The controller 140 may detect a defect of the OLED based on the sensing value received from the analog-to-digital converter ADC.

The above defect detection process may be sequentially performed on the basis of at least one sub-pixel line. The controller 140 may sequentially apply gate signals to the plurality of gate lines GL so that the defect detection process BDP_P of the OLED may be sequentially performed on each sub-pixel line. The controller 140 may store locations of sub-pixel lines, pixels, and/or sub-pixels SP in which the OLED is detected as defective in the memory.

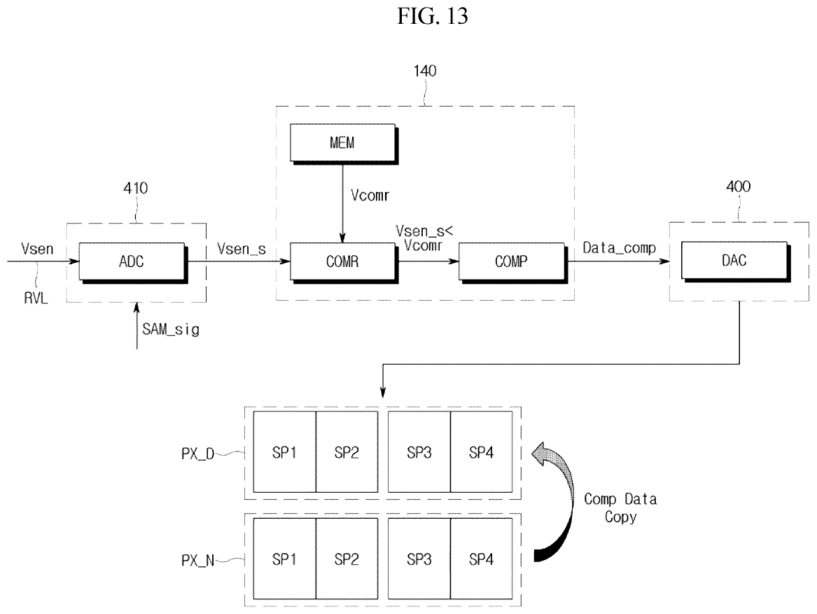

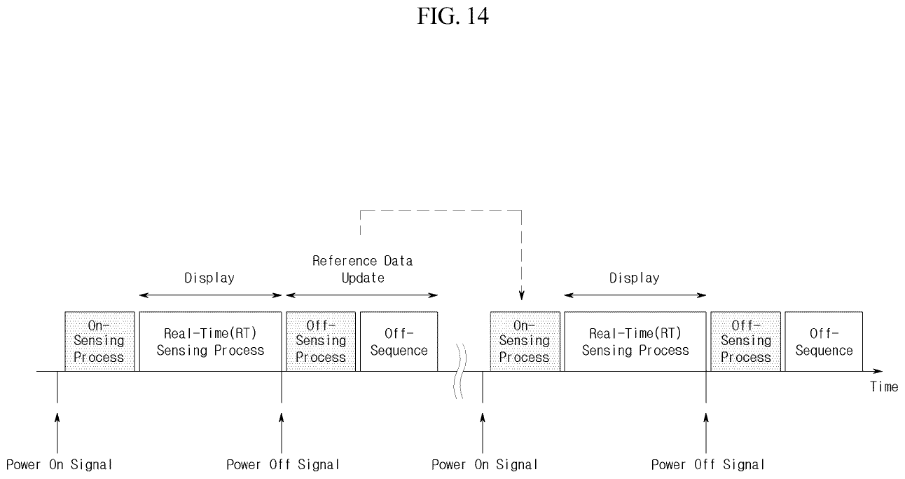

Hereinafter, the operation for the defect detection of the OLED will be described in detail with reference to FIGS. 13 and 14.

FIG. 13 is a view illustrating defect detection and luminance control of the organic light-emitting diode according to the first embodiment of the present disclosure.

Referring to FIG. 13, the sensing circuit 410 may receive a sampling switch control signal SAM_sig from the controller 140 and based on this, turn on the sampling switch SAM.

When the sampling switch SAM is turned on, the analog-to-digital converter ADC may sense the voltage of the sensing line SL connected by the sampling switch SAM, convert the sensed voltage Vsen into a sensing value Vsen_s corresponding to a digital value, and output the sensing value Vsen_s to the controller 140.

As described above, the controller 140 may include the memory MEM and a comparator COMR. The memory MEM may store a comparison reference voltage for determining whether an OLED is short-circuited. The comparator COMR may compare the sensing value Vsen_s to a comparison voltage value Vcomr and determine whether the OLED of the sub-pixel SP subjected to defect detection is short-circuited.

The comparison voltage value Vcomr to be described below is a comparison voltage value Vcomr for defect detection of the OLED.

The comparison voltage value Vcomr may be determined based on the image driving reference voltage VpreR. The comparison voltage value Vcomr may be less than the image driving reference voltage VpreR. The comparison voltage value Vcomr may be calculated by subtracting a preset value from the image driving reference voltage VpreR. For example, the image driving reference voltage VpreR may be about 4.5 V, the preset value may be about 150 mV, and the comparison voltage value Vcomr may be about 4.35 V, but the present disclosure is not limited thereto.

In the present embodiment, since the black data voltage and the image driving reference voltage VpreR are used to exclusively detect a defect of the OLED, detection conditions may be tightly set so that a difference between the comparison voltage value Vcomr and the image driving reference voltage VpreR is not large. Accordingly, it is possible to significantly increase detection sensitivity and accuracy compared to the method of detecting a defect of an OLED using a difference between a compensation value of a specific sub-pixel SP calculated by threshold voltage sensing and compensation values of neighboring sub-pixels SP.

When the sensing value is the comparison voltage value Vcomr or more, the comparator COMR may determine that the OLED is normal. In this case, the controller 140 may output a control signal for normal driving of the display apparatus 100. For example, the controller 140 may output control signals for a subsequent sensing process to the gate driving circuit 130 and the data driving circuit 120.

When the sensing value is less than the comparison voltage value Vcomr, the comparator COMR may determine that the OLED is defective. When it is determined that the OLED is defective, the controller 140 may change the image data DATA supplied to the data driving circuit 120.

According to a design, the comparator COMR may determine that the OLED is normal when a difference (an absolute value) between the sensing value and the comparison voltage value Vcomr is within a preset deviation range and determine that the OLED is defective when the deviation is out of the preset deviation range. Here, the preset deviation range may, for example, range from about 0 mV to 150 mV.

The controller 140 may change the image data DATA based on compensation data of a pixel (hereinafter referred to as a “normal pixel PX_N”) adjacent to a pixel (hereinafter referred to as a “defective pixel PX_D”) in which it is determined that the OLED is defective. The normal pixel PX_N may be a neighboring pixel in a left, right, top, or bottom direction of the defective pixel PX_D. The normal pixel PX_N and the defective pixel PX_D may be located in the same sub-pixel line or located in different neighboring sub-pixel lines, respectively.

The controller 140 may apply the same compensation value for compensation of the normal pixel PX_N to the defective pixel PX_D and change the image data DATA. The compensation value for the compensation of the normal pixel PX_N may be calculated by the on-sensing process and/or the real-time sensing process before the defect detection process is performed and stored in the memory MEM.

The compensation value for the compensation of the normal pixel PX_N may include a compensation value for threshold voltage deviation compensation and a compensation value for mobility deviation compensation. The compensation value for the threshold voltage deviation compensation and/or the compensation value for mobility deviation compensation of the defective pixel PX_D may be replaced with the compensation value of the normal pixel PX_N. That is, in the image data DATA change processing, the compensation value for the threshold voltage deviation compensation and/or the compensation value for the mobility deviation compensation of the defective pixel PX_D, which have been acquired before the defect detection process is performed, may be ignored.

By not applying the compensation values calculated by the on-sensing process and/or the real-time sensing process performed before the defect detection process to the defective pixel PX_D, but copying a compensation value of a neighboring normal pixel PX_N and applying the compensation value to the defective pixel PX_D, the corresponding pixel can be prevented from being a bright spot due to overcompensation.

In the display apparatus 100 according to the embodiments of the present disclosure, a component for detecting a short circuit defect of an OLED, for example, the defect detection circuit 900 described in FIG. 10, is omitted, and a circuit configuration and a sensing process for sensing the characteristic values of the driving transistor DRT may be used for defect detection, thereby simplifying the structure of the display apparatus 100 and significantly reducing the manufacturing cost.

In addition, every time the conventional display apparatus 100 is driven, the sensing of the characteristic value of the driving transistor DRT is performed using the initial reference data acquired by the sensing process performed before the display apparatus 100 is shipped to customers and stored in a non-volatile memory, and the update for the reference data after the shipment to the customers has not been done. Accordingly, when the display apparatus 100 is turned off for a predetermined time and then turned on, it is difficult to separately sense the defect of the OLED and the changes in characteristic values of the driving transistor DRT that occur due to a panel crack etc. during the predetermined period (the period during which the display apparatus 100 is not driven).

On the other hand, the display apparatus 100 according to the embodiments of the present disclosure may store (update) the characteristic value data of the driving transistor DRT before the end of driving of the previous display apparatus 100 as reference data RT_REF and use the data to detect a defect when the next display apparatus 100 is driven to separately detect the defect of the driving transistor DRT and/or the OLED and the changes in the characteristic values of the driving transistor DRT that occur during the period during which the display apparatus 100 is turned off.

In addition, the display apparatus 100 according to the embodiments of the present disclosure may separately detect a short circuit of the OLED through one process, and according to a design, the display apparatus 100 may further sense the degradation in characteristic values of the driving transistor DRT. Accordingly, the sensing and defect detection process for the normal operation of the display apparatus 100 can be simplified significantly.

FIG. 14 is a view illustrating update of reference data according to the first embodiment of the present disclosure.

Referring to FIG. 14, the comparator COMR may calculate data for comparison based on the reference data RT_REF stored in the memory MEM. According to a design, the comparator COMR may receive data for comparison from the outside. Here, the memory MEM may be a non-volatile memory, but is not limited thereto.

The data for comparison may be a value calculated using the reference data RT_REF. Alternatively, the data for comparison may be substantially the same as the reference data RT_REF. That is, the comparator COMR may calculate the data for comparison to perform comparison processing and perform comparison processing using the reference data RT_REF without calculating the data for comparison.

The data for comparison may be a specific value or a specific range. Hereinafter, an example in which the data for comparison is a specific range (hereinafter referred to as a “reference range REF”) will be described.

Referring to the left side of FIG. 14, when a turn-on signal is generated, the driving of the display apparatus 100 may start, and when a turn-off signal is generated, the driving of the display apparatus 100 may be finished.

As described above, the mobility sensing process may be performed as an on-sensing process and/or a real-time sensing process during the driving of the display apparatus 100.

Data acquired by the mobility sensing process may be stored for each pixel in the volatile memory and used for compensating the image data DATA during the driving of the display apparatus 100. Final data acquired by the mobility sensing process before the driving (the display driving) of the display apparatus 100 is finished may be stored as the reference data RT_REF in the memory MEM before the display apparatus 100 is turned off. That is, the reference data RT_REF may be updated before the display apparatus 100 is completely turned off after the power-off signal is generated every time the display apparatus 100 is driven.

Referring to the right side of FIG. 14, the stored reference data RT_REF may be used as data for the next defect detection. That is, the controller 140 may perform the defect detection of the OLED based on the reference data RT_REF stored before the last power-off after the last power-off signal is generated.

The reference range REF may be calculated based on the reference data RT_REF acquired by the mobility sensing process performed as the real-time sensing process during the driving of the previous display apparatus 100 and stored in the memory MEM before the display apparatus 100 is turned off.

Here, the reference data RT_REF may include at least one of the voltage Vsen sensed from the sensing line SL, the slope of the waveform of the sensed voltage Vsen, and the mobility and compensation value of the driving transistor DRT, which are calculated based on the slope. Hereinafter, an example in which the reference range REF is a value corresponding to the slope of the waveform of the sensed voltage Vsen.

A maximum value REF_max and minimum value REF_min of the reference range REF may be calculated by adding or subtracting a preset value to or from the reference data RT_REF. The preset value may be a value obtained by multiplying the reference range REF by a preset weight. The preset weight may be set in consideration of a sensing deviation.

For example, the reference range REF may have the sum of the reference data RT_REF and a value obtained by multiplying the reference data by about 0.2 as an upper limit and a difference between the reference data RT_REF and the value obtained by multiplying the reference data by about 0.2 as a lower limit. For another example, the reference range REF may have a value obtained by adding 0.6 V to the reference data RT_REF as an upper limit and a value obtained by subtracting 0.6 V from the reference data RT_REF as a lower limit.

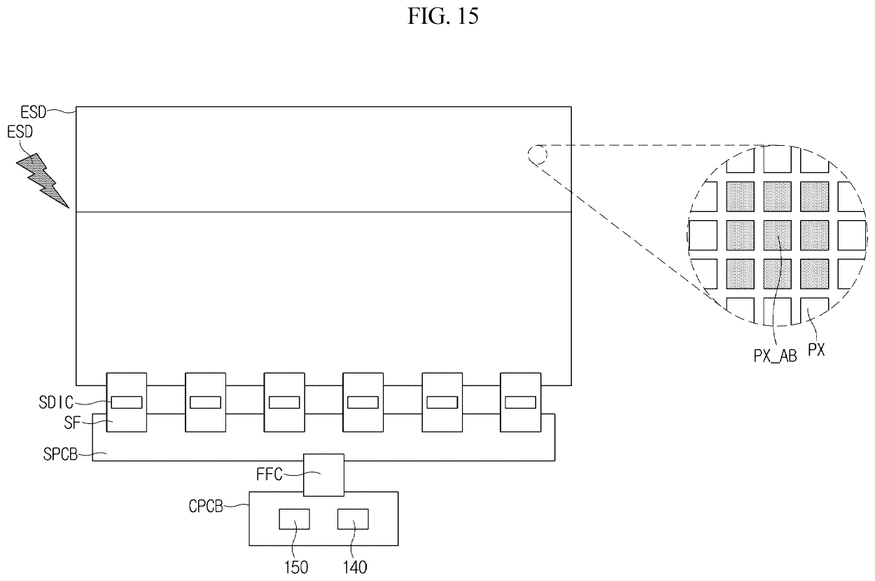

FIG. 15 is a view illustrating detecting defects of a driving transistor and/or an organic light-emitting diode according to a second embodiment of the present disclosure.

Since the embodiment of FIG. 15 is substantially the same as or similar to the mobility sensing process described in FIGS. 11 to 14 except that the mobility sensing process (or the defect detection process) further includes an additional operation to be described below, overlapping description thereof will be omitted below.

As described above in FIG. 8, the plurality of pixels SL may be arranged on the display panel, and one pixel PX may include the plurality of sub-pixels SP.

Referring to FIG. 15, the controller 140 may generate and output the defect detection signal BDP only when defects of the driving transistor DRT and/or the OLED are detected in n or more pixels PX.

The controller 140 may detect a pixel PX including a sub-pixel SP in which the driving transistor DRT and/or the OLED are detected as defective as a defective pixel PX_AB. Specifically, when the slope of the waveform of the sensed voltage Vsen of the specific sub-pixel SP is out of the reference range REF, the controller 140 may detect the driving transistor DRT and/or the OLED of the corresponding sub-pixel SP as defective and detect the pixel PX including the corresponding sub-pixel SP as the defective pixel PX_AB.

The controller 140 may generate and output the defect detection signal BDP when at least one pixel PX around the specific defective pixel PX_AB is a defect detection pixel PX.

For example, as illustrated in FIG. 15, the controller 140 may generate and output the defect detection signal BDP when all nine pixels adjacent to the specific defective pixel PX_AB in left, right, top, and bottom directions and a diagonal direction are defective pixels PX_AB. The number of adjacent defective pixels PX_AB that serve as a reference for generating and outputting the defect detection signal BDP may vary according to a design.

Since the controller 140 generates the defect detection signal BDP only when a preset number or more of adjacent pixels SL is detected as the defective pixel PX_AB, the display apparatus 100 according to the present embodiment can minimize the influence of noise, such as electrostatic discharge (ESD), and improve the reliability of defect detection.

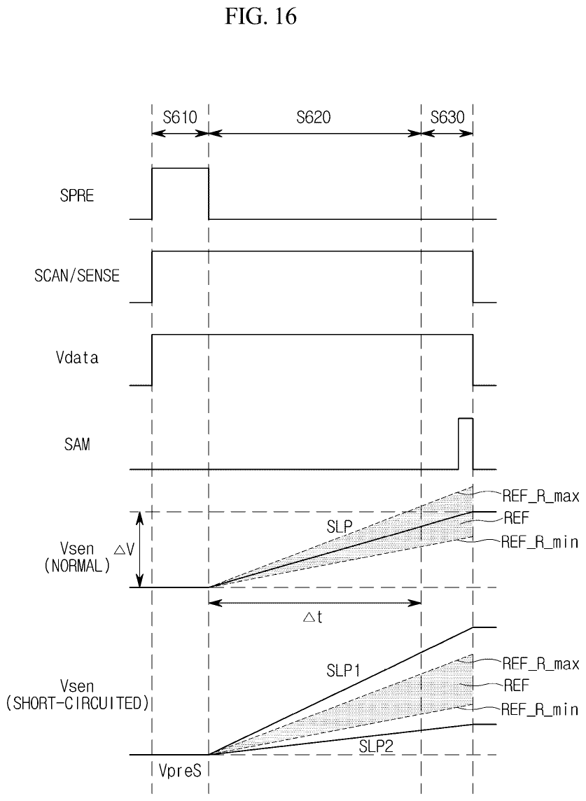

FIG. 16 is a view illustrating a driving timing diagram for defect detection of the organic light-emitting diode according to the first embodiment of the present disclosure.

Referring to FIGS. 6 and 16, the display apparatus 100 according to the embodiments of the present disclosure may detect a defect (a short circuit) of the driving transistor DRT and/or the OLED in a manner that is substantially the same as or similar to the above mobility sensing process of the driving transistor DRT. That is, the embodiments of the present disclosure may detect defects of the driving transistor DRT and/or the OLED using the mobility sensing driving method.

The mobility sensing process and the defect detection process may be performed together as a single process. It can be understood that mobility sensing is further performed during the defect detection process, and it can be understood that defect detection is further performed during the mobility sensing process.

For example, in the mobility sensing process of the driving transistor DRT described above with reference to FIG. 6, in addition to the mobility sensing of the driving transistor DRT, the defect detection of the driving transistor DRT and/or the OLED may be further performed. However, the present disclosure is not limited thereto, and the mobility sensing and the defect detection may each be performed as a separate process. For example, during a period before display driving after the power-on signal of the display apparatus 100 is generated, the defect detection process and the mobility sensing process may be performed.

The defect detection process may be performed as an on-sensing process. The mobility sensing may be performed as an on-sensing process and a real-time process. The defect detection process and the mobility sensing may be performed together in one on-sensing process. According to a design, the mobility sensing may be performed only as a real-time process.

Hereinafter, in the mobility sensing process described in FIG. 6, a case in which the defect detection of the driving transistor DRT and/or the OLED is performed together will be described.

The mobility sensing process to be described below may be referred to as a defect detection process.

The mobility sensing process in which the defect detection of the driving transistor DRT and/or the OLED is performed together is an on-sensing process and may be performed before display driving after the power-on signal is generated. The on-sensing process may be performed through substantially the same operation as the mobility sensing process.

In the mobility sensing process, the initializing operation S610, the tracking operation S620, and the sampling operation S630 may be performed sequentially.

Since the control of the gate signals SCAN and SENSE, the first and second transistors T1 and T2, the driving transistor DRT, the switches SPRE and SAM, etc. in the operations S610, S620, and S630 of the mobility sensing process is as described above in FIG. 6, overlapping description thereof will be omitted below.

As described above in FIG. 6, in the initializing operation S610, the first node N1 and the second node N2 may be initialized to the data voltage Vdata for mobility sensing driving and the sensing driving reference voltage VpreS, respectively. In this case, charges corresponding to the data voltage Vdata for mobility sensing driving may be charged at one end of the storage capacitor Cst connected to the first node N1, and charges corresponding to the sensing driving reference voltage VpreS may be charged at the other end of the storage capacitor Cst connected to the second node N2.

When defect detection is performed simultaneously in the mobility sensing process, a high voltage that turns on the driving transistor DRT may be used as the data voltage Vdata (the data voltage for mobility sensing driving). The high voltage may be a voltage that does not cause the OLED to emit light. In addition, the ground voltage, that is, 0 V, may be used as the sensing driving reference voltage VpreS. For example, the data voltage Vdata may range from about 5 V to 6 V, but is not limited thereto.

In the tracking operation S620, the voltage of the second node N2 may start to rise from the sensing driving reference voltage VpreS.

When the preset time Δt has elapsed from the time point at which the sensing driving reference switch SPRE is turned off, the sampling operation S630 may proceed.

The analog-to-digital converter ADC may sense the voltage Vsen of the sensing line SL and convert the sensed voltage Vsen into a sensing value corresponding to a digital value.

The controller 140 may calculate the slope of the waveform of the voltage Vsen of the sensing line SL (a change amount of the voltage Vsen of the sensing line SL per unit time) based on the sensing value output from the analog-to-digital converter ADC, the preset time, and the sensing driving reference voltage VpreS.

The slope of the voltage Vsen sensed from the sensing line SL may vary according to when the driving transistor DRT and the OLED are normal, when a short circuit occurs in the driving transistor DRT, or when a short circuit occurs in the OLED.

For example, when a short circuit occurs in the driving transistor DRT, the sensing driving reference voltage VpreS may rise with a larger slope SLP1 than a case in which the driving transistor DRT is normal due to a leakage current of the driving transistor DRT. For another example, when a short circuit occurs in the OLED, the sensing driving reference voltage VpreS may rise with a smaller slope SLP2 than a case in which the OLED is normal due to a leakage current of the OLED.

When the preset time Δt is sufficiently long, the sensed voltage Vsen may reach a saturation voltage. The saturation voltage may vary according to when the driving transistor DRT and the OLED are normal, when a short circuit occurs in the driving transistor DRT, or when a short circuit occurs in the OLED. The sensed voltage Vsen may rise to the driving voltage EVDD or fall to the base voltage EVSS or the ground voltage according to the degree to which the driving transistor DRT or the OLED is short-circuited.

The controller 140 may compare the voltage Vsen sensed from the sensing line SL or the slope of the waveform of the sensed voltage Vsen with the pre-stored reference data or data calculated based on the reference data and detect defects of the driving transistor DRT and/or the OLED. The operation of the controller 140 may be performed by the comparator COMR to be described below.

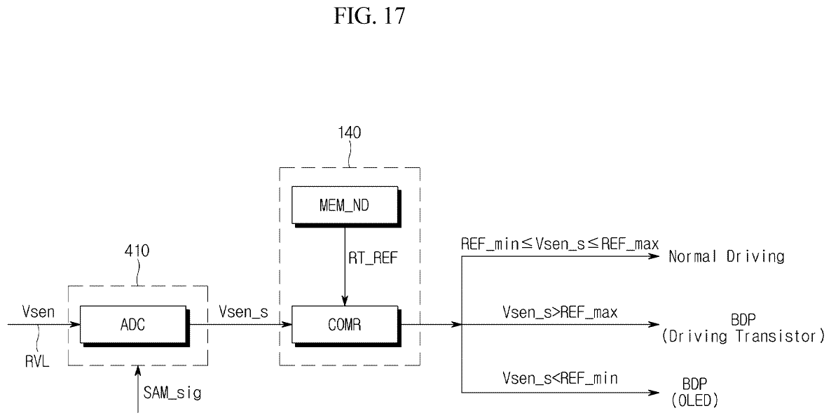

Specific defect determination will be described in more detail with reference to FIG. 17 below.

FIG. 17 is a view illustrating a defect detection process of a driving transistor and/or an organic light-emitting diode according to the third embodiment of the present disclosure.

Referring to FIG. 17, in the sampling operation S630, the sensing circuit 410 may receive the sampling switch control signal SAM_sig from the controller 140 and based on this, may turn on the sampling switch SAM.

When the sampling switch SAM is turned on, the analog-to-digital converter ADC may sense the voltage of the sensing line SL connected by the sampling switch SAM, convert the sensed voltage Vsen into a sensing value Vsen_s corresponding to a digital value, and output the sensing value Vsen_s to the controller 140.

The controller 140 may include the compensator COMR and the memory MEM.

The memory MEM may store defect detection data of the driving transistor DRT and/or the OLED. The memory MEM may include a volatile memory and a nonvolatile memory MEM_ND.

The comparator COMR may determine whether the driving transistor DRT and/or the OLED of the sub-pixel SP, which are subjected to defect detection, are defective based on the reference data RT_REF stored in the memory MEM and the sensing value Vsen_s received from the analog-to-digital converter ADC.

The comparator COMR or the controller 140 may output a corresponding control signal based on the result of determining whether the driving transistor DRT and/or the OLED are defective.

According to a design, the compensator COMP may also serve as the comparator COMR. That is, the compensator COMP and the comparator COMR may be implemented as one processor or separate processors.

A reference value REF may refer to a specific value or a specific range. Hereinafter, an example in which the reference value REF is set to a specific range (hereinafter referred to as a “reference range”) will be described.

Referring to FIGS. 13, 15, and 17, when the slope of the waveform of the sensed voltage Vsen is within the reference range REF, the comparator COMR may determine that the driving transistor DRT and the OLED are normal. In this case, the controller 140 may output a control signal for normal driving of the display apparatus 100.

When the slope of the waveform of the sensed voltage Vsen is within the reference range REF, as described above with reference to FIG. 6, the comparator COMR or the compensator COMP may calculate the mobility of the driving transistor DRT and correct the image data DATA based on the calculated mobility.

As described above, when a short circuit occurs in the driving transistor DRT, the slope of the waveform of the sensed voltage Vsen may increase, and when a short circuit occurs in the OLED, the slope of the waveform of the sensed voltage Vsen may decrease.

When the slope of the waveform of the sensed voltage Vsen is larger than the upper limit REF_max of the reference range REF (see “SLP1” in FIG. 16), the comparator COMR may determine that the driving transistor DRT is defective (a short circuit). In this case, the controller 140 may output the defect detection signal BDP corresponding to the defect of the driving transistor DRT, and the display apparatus 100 may perform the operation corresponding to the output defect detection signal BDP.

For example, the comparator COMR may generate the defect detection signal BDP, output the defect detection signal BDP to the PMIC 150, and the PMIC 150 may turn off the power source of the display apparatus 100 based on the received defect detection signal BDP.

When the slope of the waveform of the sensed voltage Vsen is less than the lower limit REF_min of the reference range REF (see “SLP2” in FIG. 16), the comparator COMR may determine that the OLED is defective (a short circuit). In this case, the controller 140 may output the defect detection signal BDP, and the display apparatus 100 may perform the operation corresponding to the output defect detection signal BDP. For example, the controller 140 may correct the image data DATA for luminance compensation of a sub-pixel or pixel detected as defective.

The controller 140 may output different defect detection signals BDP according to when the driving transistor DRT is defective or when the OLED is defective. For example, the controller 140 may output a first defect detection signal when the driving transistor DRT is defective and output a second defect detection signal different from the first defect detection signal when the OLED is defective.

The above description and the accompanying drawings are merely illustrative of the technical scope of the present disclosure, and those skilled in the art to which the present disclosure pertains can perform various changes or modifications, such as coupling, separation, substitution, and change of components, without departing from the essential characteristics of the present disclosure. Accordingly, the embodiments disclosed herein are not intended to limit the technical scope of the present disclosure, but to describe the same, and the scope of the technical scope of the present disclosure is not limited by these embodiments. The scope of the present disclosure should be construed according to the appended claims, and all equivalents of the claims should be construed as being included in the scope of the present disclosure.

What is claimed is:

1. A display apparatus, comprising:
a display panel on which a plurality of sub-pixels are arranged, each of the plurality of sub-pixels including an organic light-emitting diode and a driving transistor for driving the organic light-emitting diode;
a plurality of sensing lines disposed on the display panel;
a sensing circuit configured to sense voltages of the plurality of sensing lines; and
a controller configured to determine whether the organic light-emitting diode is defective based on pre-stored reference data,
wherein a process for determining whether the organic light-emitting diode is defective is performed before an off-sensing process after a power-off signal is generated.

2. The display apparatus of claim 1, wherein the reference data is updated based on data acquired by a mobility sensing process of the driving transistor, which is performed in real time during display driving.

3. The display apparatus of claim 2, wherein the update of the reference data is performed before the display apparatus is completely turned off after the power-off signal is generated.

4. The display apparatus of claim 3, wherein the updated reference data is stored in a non-volatile memory.

5. The display apparatus of claim 4, wherein the controller is configured to perform defect detection of the organic light-emitting diode based on the reference data stored before last power-off after a last power-off signal is generated.

6. The display apparatus of claim 2, wherein the reference data is a slope of a waveform of a sensing line voltage sensed by mobility sensing of the driving transistor, which is performed in real time during display driving, and a reference range is calculated by adding or subtracting a preset value to or from the reference data.

7. The display apparatus of claim 1, wherein mobility sensing of the driving transistor is performed before display driving after a power-on signal is generated.

8. The display apparatus of claim 1, wherein the controller comprises:
a memory configured to store the reference data; and
a comparator configured to calculate a reference range based on the reference data, compare a slope of a waveform of a sensed voltage with the reference range, and output a defect detection signal of the organic light-emitting diode,
wherein the sensed voltage is one of the sensed voltages.

9. The display apparatus of claim 8, wherein the controller is configured to output a defect detection signal corresponding to a defect of the driving transistor when a slope of a waveform of the sensed voltage is larger than an upper limit of the reference range.

10. The display apparatus of claim 8, wherein the controller is configured to output a defect detection signal corresponding to a defect of the organic light-emitting diode when a slope of a waveform of the sensed voltage is less than a lower limit of the reference range.

11. The display apparatus of claim 1, wherein a plurality of pixels are arranged on the display panel, and the pixel includes at least one sub-pixel, and
wherein the controller detects a pixel as defective, when the pixel includes a sub-pixel of which an organic light-emitting diode is detected as defective, and
wherein when at least one pixel around the defective pixel is a defect detection pixel, the controller outputs a defect detection signal.

12. The display apparatus of claim 1, wherein one of the plurality of sub-pixels includes a first transistor electrically connected between a first node of the driving transistor and a data line, and a second transistor electrically connected between a second node of the driving transistor and a sensing line, and
a gate node of the first transistor and a gate node of the second transistor are connected to one gate line,
wherein the sensing line is one of the plurality of sensing lines.

13. The display apparatus of claim 1, wherein, when the process for determining whether the organic light-emitting diode is defective is performed, the controller changes image data supplied to a data driving circuit when a voltage sensed by the sensing circuit is less than a preset second comparison voltage value,
wherein the voltage is one of the voltages sensed by the sensing circuit.

14. The display apparatus of claim 13, wherein the process for determining whether the organic light-emitting diode is defective includes an initializing operation, a tracking operation, and a sampling operation.

15. The display apparatus of claim 14, wherein one of the plurality of sub-pixels includes a first transistor electrically connected between a first node of the driving transistor and a data line, and a second transistor electrically connected between a second node of the driving transistor and a sensing line, and
in the initializing operation, the tracking operation, and the sampling operation, a gate signal of a turn-on level is applied to a gate node of the first transistor and a gate node of the second transistor,
wherein the sensing line is one of the plurality of sensing lines.

16. A display apparatus, comprising:
a display panel on which a plurality of sub-pixels are arranged, each of the plurality of sub-pixels including an organic light-emitting diode and a driving transistor for driving the organic light-emitting diode;
a plurality of sensing lines disposed on the display panel;
a sensing circuit configured to sense voltages of the plurality of sensing lines; and
a controller configured to determine whether the organic light-emitting diode is defective based on pre-stored reference data,
wherein the reference data is updated based on data acquired by a mobility sensing process of the driving transistor, which is performed in real time during display driving.

17. The display apparatus of claim 16, wherein the update of the reference data is performed before the display apparatus is completely turned off after a power-off signal is generated.

18. The display apparatus of claim 17, wherein the controller performs defect detection of the organic light-emitting diode based on the reference data stored before last power-off after a last power-off signal is generated.

19. The display apparatus of claim 16, wherein the controller comprises:
a memory configured to store the reference data; and
a comparator configured to calculate a reference range based on the reference data, compare a slope of a waveform of a sensed voltage with the reference range, and output a defect detection signal of the organic light-emitting diode,
wherein the sensed voltage is one of the sensed voltages.

20. The display apparatus of claim 16, wherein a process for determining whether the organic light-emitting diode is defective is performed before an off-sensing process after a power-off signal is generated.
